(19) United States
(12) Patent Application Publication
(10) Pub. No.: US 2019/0042608 A1
(43) Pub. Date: Feb. 7, 2019

(54) VERSION MANAGEMENT SYSTEM, VERSION MANAGEMENT APPARATUS, AND NON-TRANSITORY RECORDING MEDIUM

(71) Applicant: Yousuke HIRANO, Tokyo (JP)

(72) Inventor: Yousuke HIRANO, Tokyo (JP)

(73) Assignee: Ricoh Company, Ltd., Tokyo (JP)

(21) Appl. No.: 15/743,074

(22) PCT Filed: Aug. 19, 2016
(86) PCT No.: PCT/JP2016/003794

§ 371 Date: Jan. 9, 2018

(30) Foreign Application Priority Data
Aug. 26, 2015 (JP) 2015-166704

(51) Int. Cl. G06F 17/30; G06Q 10/06

(52) U.S. Cl. CPC G06F 17/30309; G06F 17/30424; G06Q 10/06313; G06F 17/30554; G06F 17/30011

(57) ABSTRACT

[Object] An object is to assist in version management of a package. [Means of Achieving the Object] A version management system manages versions of packages each of which includes one or more pieces of content, and includes an acquisition unit configured to search, based on a search condition defined for a package, a content database for managing content records each of which indicates a piece of content, for content records that indicate pieces of content included in the package corresponding to the search condition; and a configuration management unit configured to store, for each of the content records acquired by the acquisition unit, a configuration management record in which identification information for identifying the package corresponding to the search condition is associated with first version information that indicates a version of the package, in a configuration management database.

### TECHNICAL FIELD

The present invention relates to a version management system, a version management apparatus, a program, and a non-transitory recording medium.

### BACKGROUND ART

A version management system to manage versions of various sorts of content such as design documents, reports, program sources, and so forth, is known. With such a version management system, it is possible to manage versions of packages or projects each of which has a plurality of pieces of content as elements of the package or the project.

Also, technology to create a configuration management folder that includes elements each having a version is known (for example, see PTL 1).

### SUMMARY OF INVENTION

### Technical Problem

In the above-described technology, version management may be complicated if elements (pieces of content) of a package, a project, or a configuration management folder are frequently changed.

For example, if a piece of content as an element of a package is added, the piece of content may be registered with a repository, or the like, for recording the corresponding change history. Thus, if pieces of content as elements of a package are frequently changed, the pieces of content may be registered with the repository each time, and complicated work may occur.

An embodiment of the present invention has been devised in consideration of the point, and has an object to assist in managing versions of packages.

### Solution to Problem

In order to achieve the object, the embodiment of the present invention is a version management system for managing versions of packages each of which includes one or more pieces of content. The version management system includes an acquisition unit configured to search, based on a search condition defined for a package, a content database for managing content records each of which indicates a piece of content, for content records that indicate pieces of content included in the package corresponding to the search condition; and a configuration management unit configured to store, for each of the content records acquired by the acquisition unit, a configuration management record in which identification information for identifying the package corresponding to the search condition is associated with first version information that indicates a version of the package, in a configuration management database.

### Advantageous Effects of Invention

According to the embodiment of the present invention, it is possible to assist in managing versions of packages.

### BRIEF DESCRIPTION OF DRAWINGS

FIG. 1 illustrates one example of a system configuration of a version management system according to a first embodiment.

FIG. 2 illustrates one example of a hardware configuration of a computer according to the first embodiment.

FIG. 3 illustrates one example of a functional configuration of the version management system 1 according to the first embodiment.

FIG. 4 illustrates one example of a content DB according to the first embodiment.

FIG. 5 illustrates one example of a package definition DB according to the first embodiment.

FIG. 6 illustrates one example of a configuration management DB according to the first embodiment.

FIG. 7 is a sequence diagram illustrating one example of a content registration process according to the first embodiment.

FIG. 8 illustrates one example of a case where a list of all the pieces of content is displayed.

FIG. 9 illustrates one example of a case where a piece of content is registered.

FIG. 10 is a sequence diagram illustrating one example of a package displaying and version registration process according to the first embodiment.

FIG. 11 illustrates one example of a case where a list of pieces of content included in a design document package is displayed.

FIG. 12 illustrates one example of a case where a version of a design document package is registered.

FIG. 13 is a flowchart illustrating one example of a content record search process according to the first embodiment.

FIG. 14A illustrates one example of a content record acquisition process.

FIG. 14B illustrates the example of the content record acquisition process.

FIG. 14C illustrates the example of the content record acquisition process.

FIG. 15 is a sequence diagram illustrating one example of a process of displaying a package of a certain version according to the first embodiment.

FIG. 16 illustrates one example of a case where a list of pieces of content included in a package of a selected version is displayed.

FIG. 17 illustrates one example of a functional configuration of a version management system 1 according to a second embodiment.

FIG. 18 illustrates one example of a content DB according to the second embodiment.

FIG. 19 is a sequence diagram illustrating one example of a content deletion process according to the second embodiment.

FIG. 20 illustrates one example of a case where a piece of content is deleted.

FIG. 21 is a flowchart illustrating one example of a content record search process according to the second embodiment.

FIG. 22 illustrates one example of a functional configuration of a version management system according to a third embodiment.

FIG. 23 illustrates one example of a configuration management DB according to the third embodiment.

FIG. 24 is a sequence diagram illustrating one example of a package displaying and version registration process according to the third embodiment.

FIG. 25 illustrates one example of setting a period.

FIG. 26 is a sequence diagram illustrating one example of a process to display a package valid at a certain date according to the third embodiment.

FIG. 27 illustrates one example of a process of displaying a list of pieces of content included in a package valid at a certain date.

### DESCRIPTION OF EMBODIMENTS

Other objects, features, and advantages will become more apparent from the following detailed description when read in conjunction with the accompanying drawings.

Embodiments of the present invention will be described with reference to the accompanying drawings.

### First Embodiment

<System Configuration>

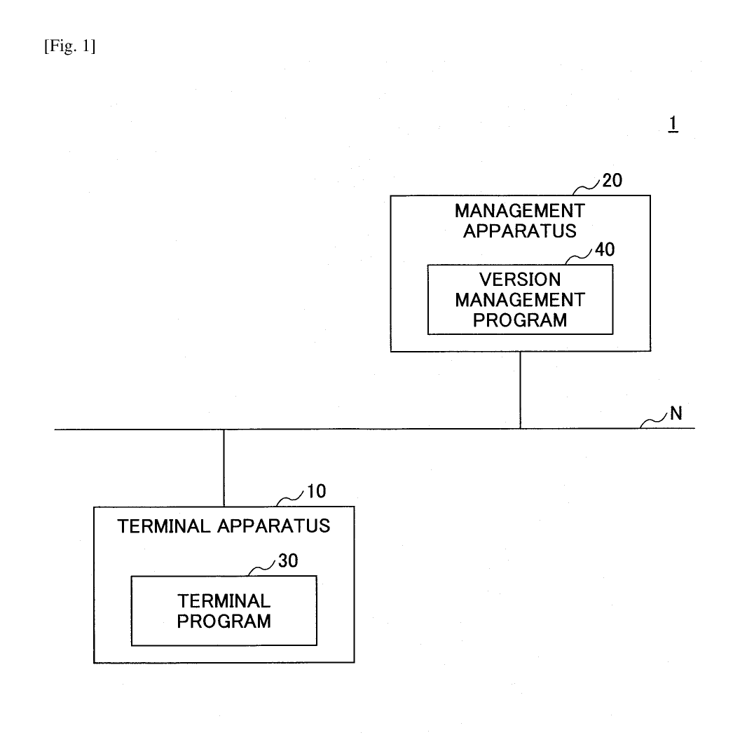

First, a version management system 1 according to a first embodiment will be descried with reference to FIG. 1. FIG. 1 illustrates one example of a system configuration of the version management system according to the first embodiment.

The version management system 1 illustrated in FIG. 1 includes a terminal apparatus 10 and a management apparatus 20 which are communicatably connected via a network N such as a LAN (Local Area Network).

The terminal apparatus 10 is an electronic apparatus such as a desktop-type personal computer or a notebook-type personal computer used by a user of the version management system 1. In the terminal apparatus 10, a terminal program 30 for the user to register pieces of content such as documents or program sources, with the management apparatus 20, and manage the versions of the registered pieces of content, is installed.

With the terminal apparatus 10, the user can manage the versions of pieces of content such as documents or program sources, and also, manage the versions of packages each of which includes one or more pieces of content.

A “piece of content”, for which the version is managed, is a document, a program source, or the like, and, for example, is a design document, a report, or a program module to implement a certain function. A “package” is a collection of pieces of content, and, for example, is a set of design documents concerning a certain development process, a set of reports concerning a certain division, or a set of program sources and instruction manuals concerning a certain product.

Note that a “package” may also be called a “project”. According to the first embodiment, each package includes one or more pieces of content. However, there may be a case where a package includes no pieces of content.

With the terminal apparatus 10, the user can register pieces of content with the management apparatus 20, and manage the respective versions of the pieces of content themselves, and also, manage the versions of packages each of which includes one or more pieces of content.

Note that, the terminal apparatus 10 may be any apparatus in which the terminal program 30 is installed, and, for example, may be one of various sorts of electronic apparatuses such as a cell phone, a smartphone, and a tablet terminal.

The management apparatus 20 is an information processing apparatus that manages the versions of pieces of content and packages. In the management apparatus 20, a version management program 40 for managing the versions of pieces of content and packages is installed.

According to the first embodiment, as a result of the version management program 40 being installed in the management apparatus 20, the versions of packages can be easily managed even when pieces of content that are elements of the packages are frequently added, for example.

Although FIG. 1 illustrates an example where the management apparatus 20 is a single information processing apparatus, the management apparatus 20 may include two or more information processing apparatuses.

<Hardware Configuration>

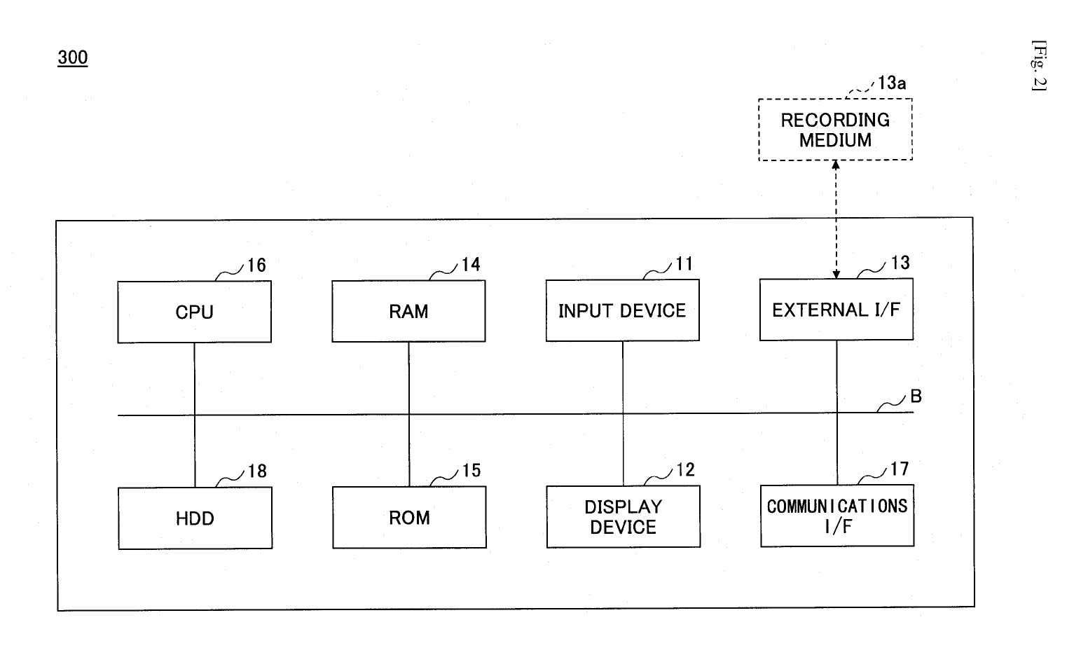

A hardware configuration of the terminal apparatus 10 and the management apparatus 20 according to the first embodiment will be described with reference to FIG. 2. FIG. 2 illustrates one example of a hardware configuration of a computer according to the first embodiment. The terminal apparatus 10 and the management apparatus 20 according to the first embodiment can be respective computers each of which has such a hardware configuration as the hardware configuration of the computer 300 illustrated in FIG. 2.

The computer 300 illustrated in FIG. 2 includes an input device 11, a display device 12, an external I/F 13, and a RAM (Random Access Memory) 14. The computer 300 further includes a ROM (Read-Only Memory) 15, a CPU (Central Processing Unit) 16, a communications I/F 17, and a HDD (Hard Disk Drive) 18. These hardware elements are mutually connected via a bus B.

The input device 11 includes a keyboard, a mouse, a touch panel, or the like, and is used by the user to input various signals to the computer 300. The display device 12 includes a display, or the like, and displays various processing results. Note that, at least one of the input device 11 and the display device 12 may be connected to the bus B when the at least one of the input device 11 and the display device 12 is actually used, and may be not connected to the bus B when the at least one of the input device 11 and the display device 12 is not actually used.

The external I/F 13 is an interface for connecting an external apparatus to the computer 300. The external apparatus may be, for example, a recording medium such as a CD (Compact Disk), a DVD (Digital Versatile Disk), a SD memory card, or a USB memory (Universal Serial Bus memory). The computer 300 can read information from and write information to the recording medium via the external I/F 13.

The RAM 14 is a semiconductor memory (storage device) that temporarily stores programs or data. The ROM 15 is a nonvolatile semiconductor memory (storage device) capable of storing data even after the power supply is turned off. The CPU 16 is a processing unit that carries out various processes by reading programs and data from, for example, the HDD 18 or the ROM 15 to the RAM 14.

The communications I/F 17 is an interface for connecting the computer 300 to the network N.

The HDD 18 is a nonvolatile memory (storage device) that stores programs and data. The programs and data stored in the HDD 18 include, for example, the terminal program 30, the version management program 40, an OS (Operating System) that is basic software controlling the entirety of the computer 300, and various programs that operate on the OS. Note that, the computer 300 may use, instead of or in addition to the HDD 18, a nonvolatile memory (storage device such as a SSD (Solid State Drive).

The terminal apparatus 10 according to the first embodiment can implement various processes as the computer 300 illustrated in FIG. 2. Also, the management apparatus 20 according to the first embodiment can implement various processes as the computer 300 illustrated in FIG. 2.

<Functional Configuration>

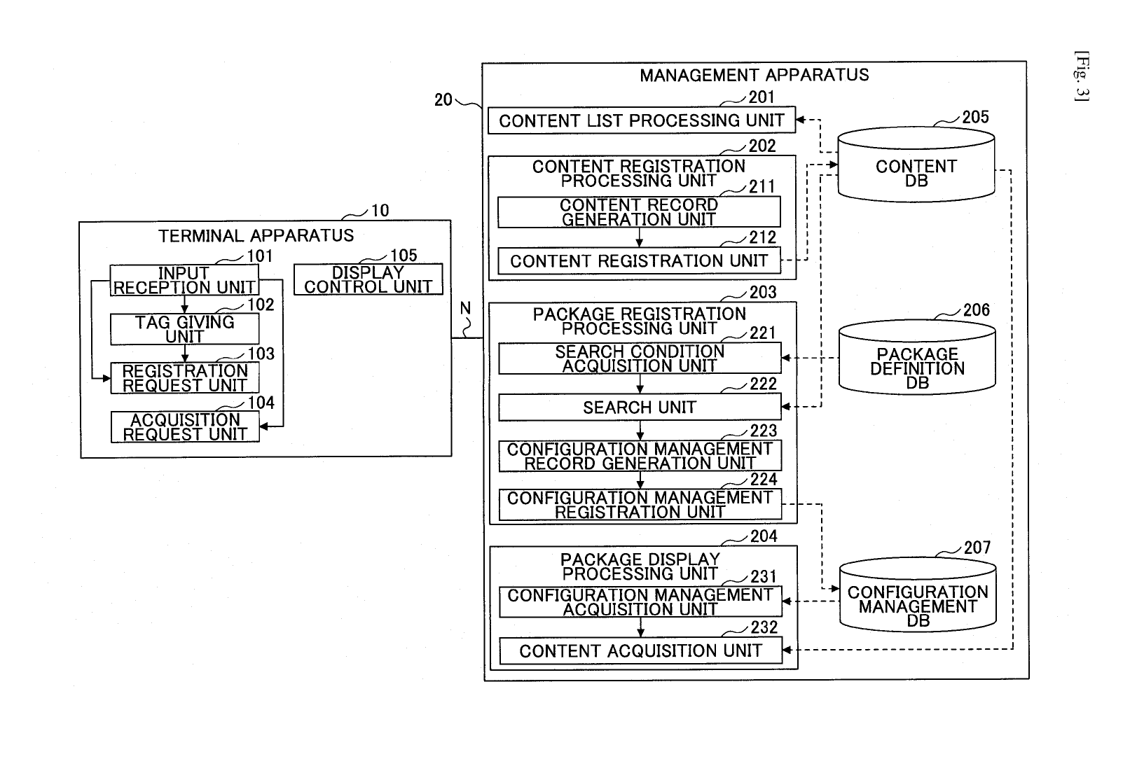

A functional configuration of the version management system 1 according to the first embodiment will be described with reference to FIG. 3. FIG. 3 illustrates one example of a function configuration of the version management system 1 according to the first embodiment.

The terminal apparatus 10 illustrated in FIG. 3 includes an input reception unit 101, a tag giving unit 102, a registration request unit 103, an acquisition request unit 104, and a display control unit 105. These units are implemented by processes carried out by the CPU 16 according to the terminal program 30 installed in the terminal apparatus 10.

The input reception unit 101 receives various input operations performed by a user. For example, the input reception unit 101 receives a display operation for displaying a list of pieces of content managed by the management apparatus 20, and a content registration operation for registering pieces of content with the management apparatus 20.

Further, the input reception unit 101 receives a package selection operation for selecting a package to display a list of pieces of content included in the package, a package version registration operation for giving a version to a package (i.e., carrying out versioning on the package) and registering the package having the version, for example.

The tag giving unit 102 associates a tag corresponding to a piece of content with content data that indicates the piece of content, when the input reception unit 101 receives a content registration operation for registering the piece of content with the management apparatus 20.

According to the first embodiment, the term “tag” means information that indicates a type of a piece of content such as a design document, a report, or a bill. However, a “tag” is not limited to this meaning, but may also mean, for example, information indicating a development process to which the piece of content belongs (i.e., “basic design”, “detailed design”, or the like), a name of a division which creates the piece of content (“market division”, “development division”, or the like), or date and time at which the piece of content is created. That is, as a tag, one of various sorts of information that indicates an attribute of the piece of content is used.

The registration request unit 103 transmits a content registration request or a package version registration request to the management apparatus 20 in response to a corresponding input operation that the input reception unit 101 has received.

The acquisition request unit 104 transmits a content acquisition request or a package acquisition request to the management apparatus 20 in response to a corresponding input operation that the input reception unit 101 has received.

The display control unit 105 displays various screen pages on the display device 12. For example, the display control unit 105 responds to a corresponding return from the management apparatus 20, to display a list of pieces of content managed by the management apparatus 20 or a list of pieces of content included in a package.

The management apparatus 20 illustrated in FIG. 3 includes a content list processing unit 201, a content registration processing unit 202, a package registration processing unit 203, and a package display processing unit 204. These units are implemented as a result of the CPU 16 carrying out processes according to the version management program 40 installed in the management apparatus 20.

The management apparatus 20 illustrated in FIG. 3 further includes a content data DB (Database) 205, a package definition DB 206, and a configuration management DB 207. These DBs can be implemented by the HDD 18, or the like. Note that, these DBs may be implemented by storage devices, or the like, connected to the management apparatus 20 via the network N.

The content list processing unit 201 responds to a content acquisition request for displaying a list of pieces of content managed by the management apparatus 20, to acquire corresponding content records from the content DB 205. A “content record” is data managed by the content DB 205. In a content record, as described later, the content data that indicate a piece of content is associated with information such as a tag and a version.

The content registration processing unit 202 responds to a content registration request for registering pieces of content with the management apparatus 20, to register the pieces of content with the management apparatus 20. The content registration processing unit 202 includes a content record generation unit 211 and a content registration unit 212. These units will be described later in detail.

The package registration processing unit 203 responds to a package acquisition request or a package version registration request, to display pieces of content included in a package or register the version of a package. The package registration processing unit 203 includes a search condition acquisition unit 221, a search unit 222, a configuration management record generation unit 223, and a configuration management registration unit 224. These units will be described later in detail.

The package display processing unit 204 responds to a package acquisition request for acquiring a package of a version registered with the package registration processing unit 203, to display the pieces of content included in the package of the version. The package display processing unit 204 includes a configuration management acquisition unit 231 and a content acquisition unit 232. These units will be described later in detail.

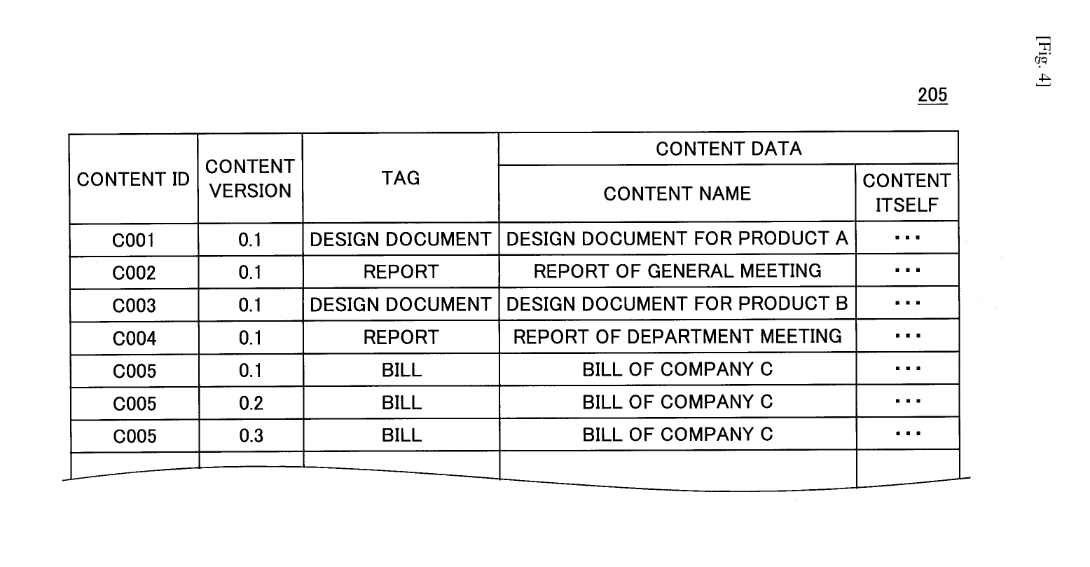

The content DB 205 manages content records. The content DB 205 will now be described in detail with reference to FIG. 4. FIG. 4 illustrates one example of the content DB according to the first embodiment.

As illustrated in FIG. 4, each of content records managed by the content DB 205 has data items, i.e., a content ID, a content version, a tag, and content data. The data item “content data” further has data items, i.e., a content name and content itself.

The data item “content data” indicates a corresponding piece of content such as a design document, a report, or a program source. The data item “content name” is a name of the piece of content, and, for example, is a file name of a design document file. The data item “content itself” is the piece of content itself created or changed by a user, and, for example, is drawing data that indicates design contents, document data that indicates report contents, or the like.

The data item “content ID” is identification information for uniquely identifying the piece of content for which the version is managed. The data item “tag” is information indicating the type of the piece of content. The data item “content version” is information indicating the version of the piece of content. According to the first embodiment, from among the same pieces of content, a piece of content having a greater version is a newer piece of content. For example, in the content DB 205 illustrated in FIG. 4, from among the three pieces of content having the content versions “0.1”, “0.2”, and “0.3”, respectively, and having the same content name “bill of company C”, the pieces of content are newer, one by one, in the stated order.

That is, from among the same pieces of content, the content data of the content version “0.2” is acquired from changing the content data of the content version “0.1”. In the same way, from among the same pieces of content, the content data of the content version “0.3” is acquired from changing the content data of the content version “0.2”.

As illustrated in FIG. 4, content records are managed in the content DB 205. In each of the content records, content data that indicates a piece of content is associated with the corresponding content ID, content version, and tag. Thus, according to the version management system 1 of the first embodiment, the version of each piece of content is managed.

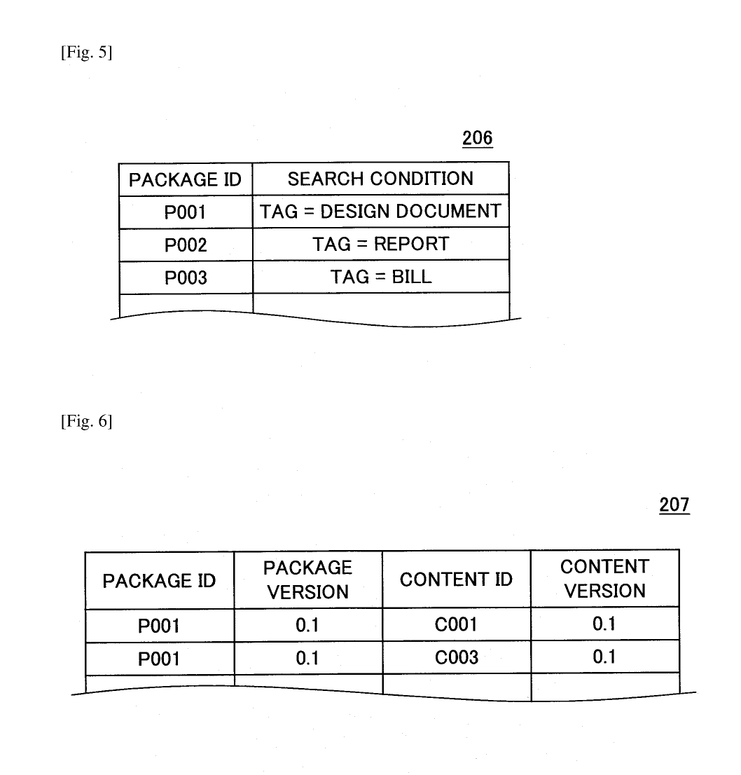

The package definition DB 206 manages package definition records. The package definition DB 206 will now be described in detail with reference to FIG. 5. FIG. 5 illustrates one example of the package definition DB according to the first embodiment.

As illustrated in FIG. 5, each of package definition records managed in the package definition DB 206 has data items, i.e., a package ID and a search condition.

The data item “package ID” is identification information for uniquely identifying a package that includes one or more pieces of content. The data item “search condition” is a condition for searching the content DB 205 for the pieces of content included in a package. For example, the package ID “P001” is associated with the search condition “tag=design document”. This record indicates that the package having the package ID “P001” includes the pieces of content indicated by the content records retrieved from the content DB 205 based on the search condition “tag=design document”. Thus, according to the version management system 1 of the first embodiment, the pieces of content, i.e., the elements of a package are defined by the corresponding search condition.

Note that, as search conditions, desired logical formulas or search formulas can be set for searching the content DB 205 for corresponding content records. For example, as a search condition, “tag=design document or report” may be set. Also, for example, if a tag indicates the date and time at which a piece of content is created, “2014/04/01≤tag≤2014/04/10”, or the like, may be set as a search condition. Thus, as a search condition, any logical formula or search formula can be set for searching the content DB 205 for corresponding content records that indicate the pieces of content, i.e., the elements of the corresponding package.

Note that, a package definition record is registered when, for example, the user of the version management system 1, or the like, newly creates a package.

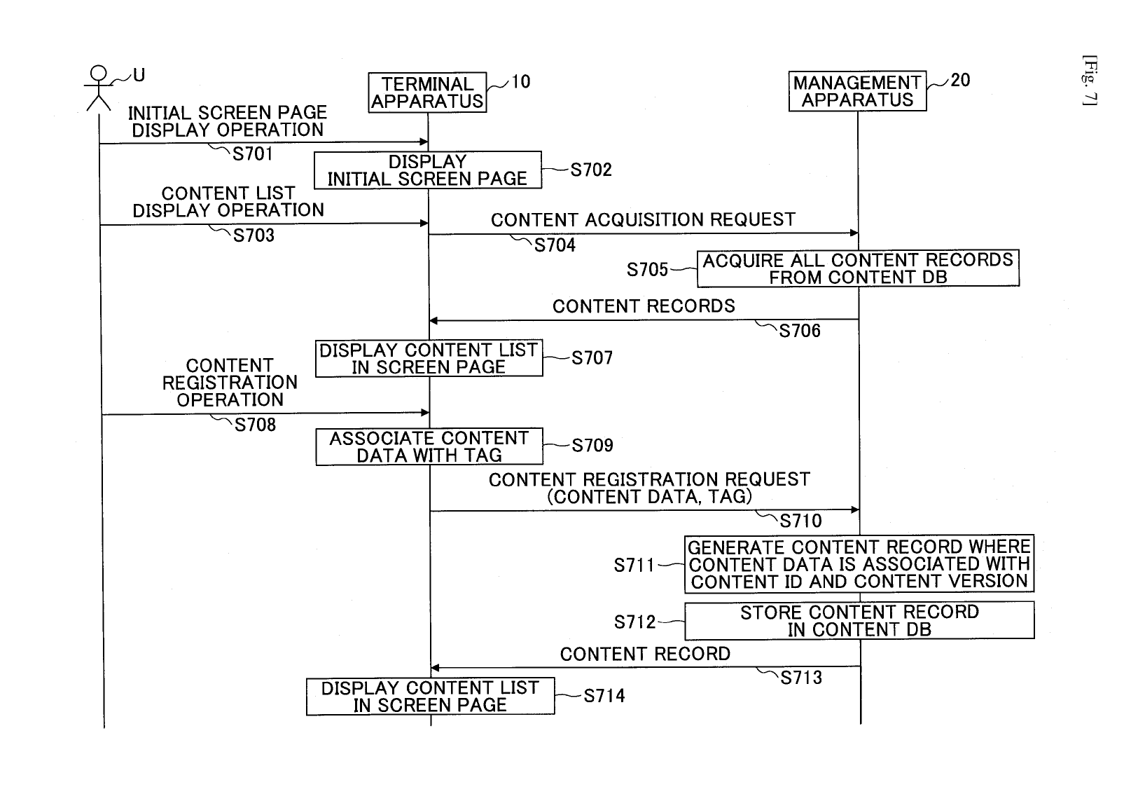

The configuration management DB 207 manages configuration management records. The configuration management DB 207 will now be described in detail with reference to FIG. 6. FIG. 6 illustrates one example of the configuration management DB according to the first embodiment.

As illustrated in FIG. 6, each of configuration management records managed by the configuration management DB 207 has data items, i.e., a package ID, a package version, a content ID, and a content version.

The data item “package ID” is, as described above, identification information uniquely identifying a package. The data items “content ID” and “content version” are, as described above, information uniquely identifying a piece of content, and information indicating the version of the piece of content, respectively. The data item “package version” is information indicating the version of the package.

Thus, in the configuration management DB 207, configuration management records in each of which a package ID and a package version are associated with a content ID and a content version are managed. Thus, it is possible to manage a configuration of the pieces of content included in the package of the version indicated by a package version.

The content record generation unit 211 generates a content record in response to a content registration request. In more detail, the content record generation unit 211 determines the content ID and the content version based on the content name of the content data included in the content registration request. Then, the content record generation unit 211 generates a content record where the content data and the tag included in the content registration request are associated with the content ID and the content version.

The content registration unit 212 stores a content record generated by the content record generation unit 211 in the content DB 205. Thus, the piece of content is registered with the management apparatus 20, and the piece of content is managed.

The search condition acquisition unit 221 responds to a package acquisition request, to acquire the package definition record corresponding to the package ID included in the package acquisition request from the package definition DB 206. Then, the search condition acquisition unit 221 acquires the search condition included in the acquired package definition record.

The search unit 222 searches the content DB 205 based on a search condition acquired by the search condition acquisition unit 221, to acquire the content records each of which satisfies the search condition.

The configuration management record generation unit 223 responds to a package version registration request, to generate configuration management records. In more detail, the configuration management record generation unit 223 generates configuration management records where the content IDs and the content versions included in content records acquired by the search unit 222 are associated with the package ID and the package version included in the package registration request.

The configuration management registration unit 224 stores configuration management records generated by the configuration management record generation unit 223 in the configuration management DB 207. Thus, in the management apparatus 20, a configuration of the pieces of content included in a package of a certain version is managed.

The configuration management acquisition unit 231 responds to a package acquisition request for acquiring a package of a version registered by the package registration processing unit 203, to acquire the configuration management records corresponding to the package ID and the package version included in the package acquisition request from the configuration management DB 207.

The content acquisition unit 232 acquires the content records corresponding to the content IDs and the content versions included in configuration management records acquired by the configuration management acquisition unit 231 from the content DB 205. Thus, in the terminal apparatus 10, the content data of the pieces of content included in a package of a certain version is acquired, and a list of the pieces of content included in the package can be displayed.

<Process Detail>

Next, the process of the version management system 1 according to the first embodiment will be described in detail.

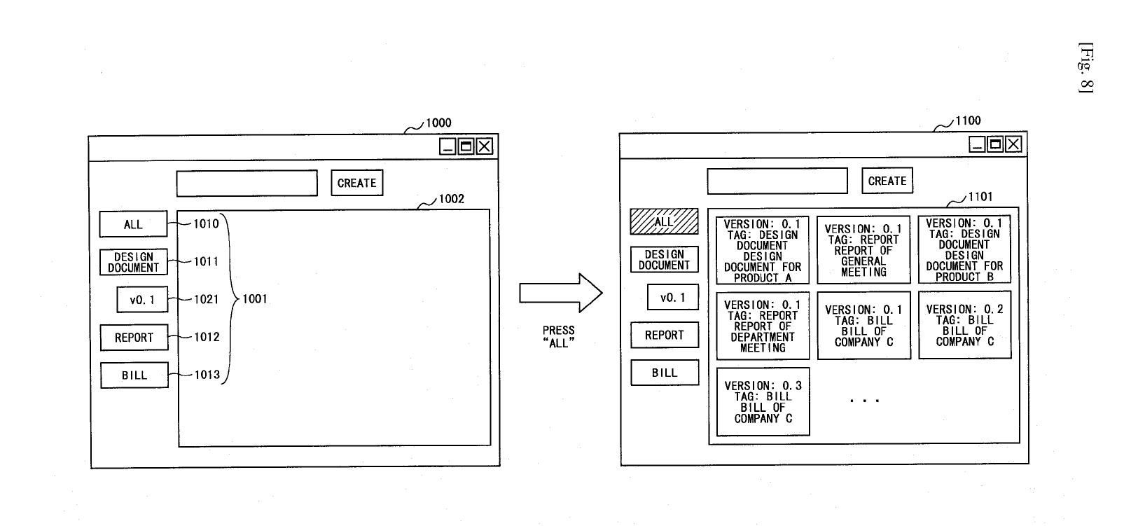

First, a process for a user U to register a piece of content with the management apparatus 20 using the terminal apparatus 10 will be described with reference to FIG. 7. FIG. 7 is a sequence diagram illustrating one example of a content registration process according to the first embodiment.

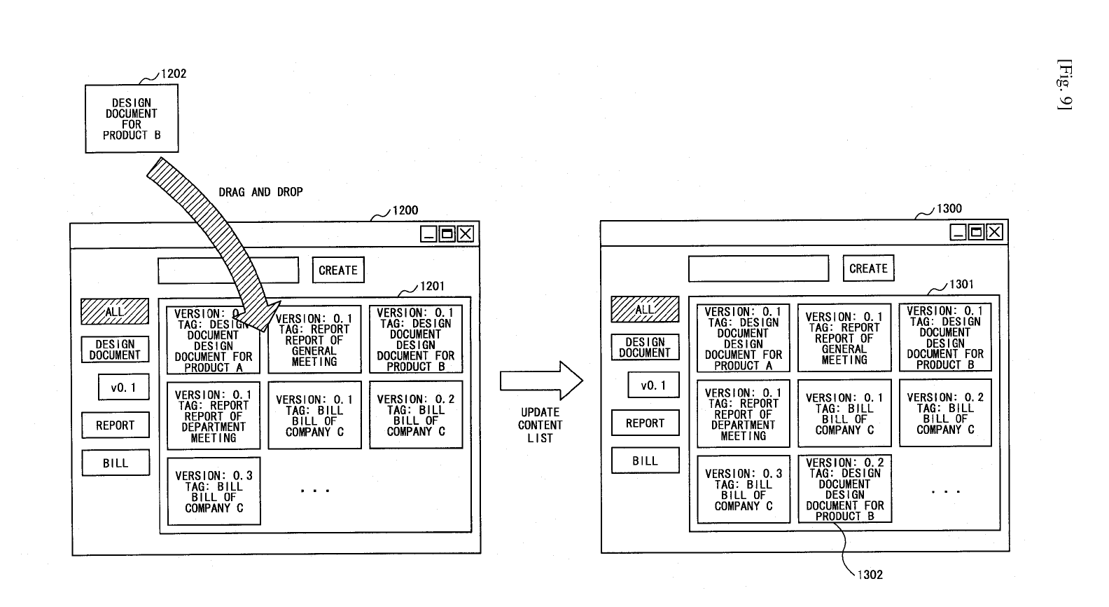

First, the user U starts, for example, the terminal program 30, and performs a display operation on the terminal apparatus 10 for displaying an initial screen page of the terminal program 30 on the display device 12 (step S701). As a result, the display control unit 105 of the terminal apparatus 10 displays, for example, a screen page 1000 such as the screen page illustrated in FIG. 8, on the display device 12 (step S702).

The screen page 1000 illustrated in FIG. 8 is the initial screen page of the terminal program 30, and includes various buttons 1001 for displaying pieces of content managed by the management apparatus 20, and a display area 1002 to display the pieces of content.

The buttons 1001 include an “all” button 1010 for displaying a list of all the pieces of content managed by the management apparatus in the display area 1002.

Also, the buttons 1001 include a “design document” button 1011 with which the package ID “P001” is associated, a “report” button 1012 with which the package ID “P002” is associated, and a “bill” button 1013 with which the package ID “P003” is associated. These buttons 1011-1013 are display components such as selectable icons for displaying lists of the pieces of content included in the packages associated with the corresponding package IDs, respectively, in the display area 1002. Below, the package having the package ID “P001” will be referred to as a “design document package”, the package having the package ID “P002” will be referred to as a “report package”, the package having the package ID “P003” will be referred to as a “bill package”.

The buttons 1001 further include a “v0.1” button 1021 for displaying a list of the pieces of content included in the design document package having the package version “0.1” in the display area 1002.

The user U performs a display operation of pressing the “all” button 1010 in the screen page 1000 for displaying a list of all the pieces of content managed by the management apparatus 20 in the display area 1002 (step S703). The input reception unit 101 of the terminal apparatus 10 receives the display operation.

When the input reception unit 101 has received the display operation, the acquisition request unit 104 of the terminal apparatus 10 transmits a content acquisition request for acquiring all the pieces of content managed by the management apparatus 20 to the management apparatus 20 (step S704).

When the content list processing unit 201 of the management apparatus 20 has received the content acquisition request, the content list processing unit 201 acquires all the content records from the content DB 205 (step S705). Then, the content list processing unit 201 of the management apparatus 20 transmits the acquired content records to the terminal apparatus 10 (step S706).

When the display control unit 105 of the terminal apparatus 10 has received the content records from the management apparatus 20, the display control unit 105 of the terminal apparatus 10 displays a screen page 1100 such as the screen page illustrated in FIG. 8 on the display device 12 based on the content records (step S707).

In a display area 1101 of the screen page 1100 illustrated in FIG. 8, a list of the pieces of content based on the received content records is displayed. That is, in the display area 1101, a list of display components such as icons representing the pieces of content managed by the management apparatus 20 is displayed. In the display components, the content versions, the tags, and the content names included in the received content records are displayed, respectively. Thus, the user U can acquire the list of the content versions, the tags, and the content names of the pieces of content managed by the management apparatus 20.

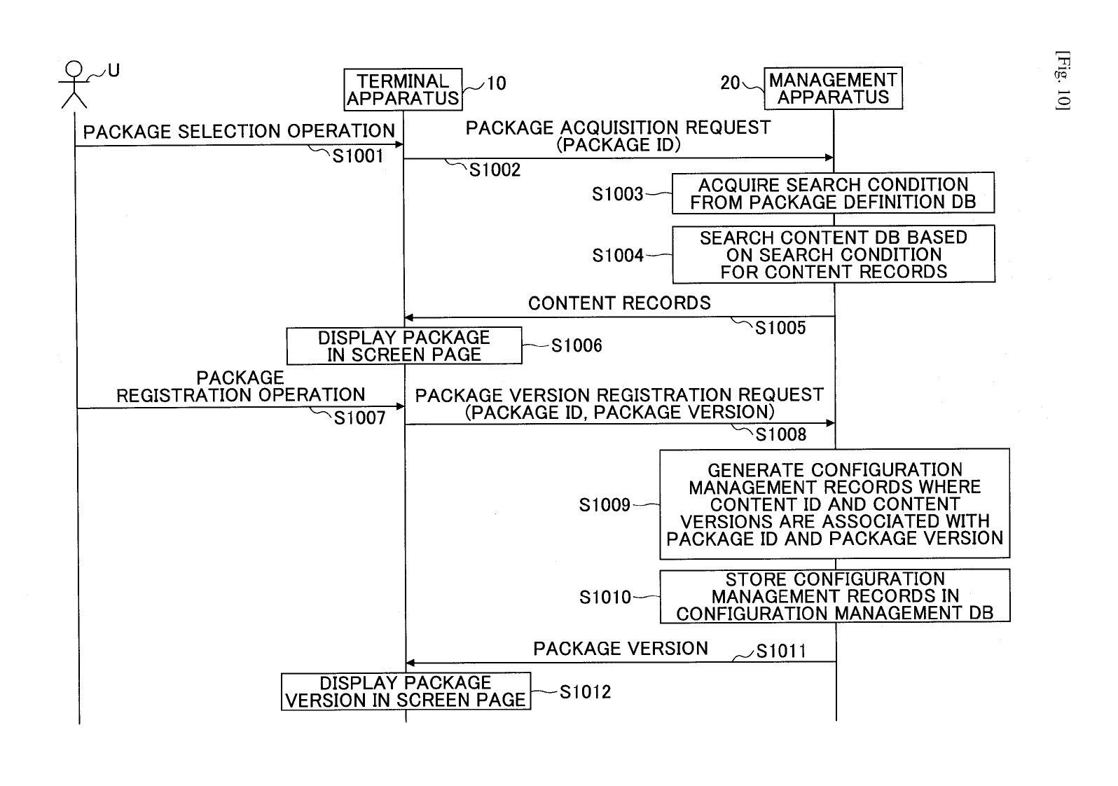

Next, the user U performs a content registration operation for registering a piece of content created or edited in the terminal apparatus 10 with the management apparatus 20 (step S708). For example, the user U drags and drops a piece of content 1202 to register in a display area 1201 where all the pieces of content managed by the management apparatus 20 are displayed, in a screen page 1200 illustrated in FIG. 9. It is assumed that the content name of the piece of content 1202 is a “design document for product B”. As a result, the input reception unit 101 of the terminal apparatus 10 receives the content registration operation, to acquire the content data of the piece of content 1202 to register.

When the input reception unit 101 has received the content registration operation, the tag giving unit 102 of the terminal apparatus 10 associates the content data of the piece of content 1202 to register with a tag corresponding to the piece of content (step S709).

For example, if the piece of content 1202 to register is a design document, the tag giving unit 102 associates the content data with a tag “design document”. In the same way, if a piece of content 1202 to register is, for example, a bill, the tag giving unit 102 associates the corresponding content data with a tag “bill”. Thus, the tag giving unit 102 associates the content data that indicates a piece of content with a tag corresponding to the piece of content to register.

Below, a description will be made assuming that the tag giving unit 102 associates the content data of the piece of content 1202 with the tag “design document”.

Next, the registration request unit 103 of the terminal apparatus 10 transmits a content registration request for registering the piece of content 1202 with the management apparatus 20 to the management apparatus 20 (step S710). The content registration request includes the content data of the piece of content 1202 to register, and the tag with which the tag giving unit 102 associates the content data.

Next, when the content record generation unit 211 of the management apparatus 20 has received the content registration request, the content record generation unit 211 determines a content ID and a content version based on the content name included in the content data. Then, the content record generation unit 211 generates a content record where the content data and the tag are associated with the content ID and the content version (step S711).

Note that, the content record generation unit 211 may determine the content ID and the content version based on, for example, the content name included in the content data.

In more detail, if there is no content record that includes the same content name as the content name included in the content data in the content DB 205, the content record generation unit 211 determines the content ID unique in the version management system 1. At this time, the content record generation unit 211 determines the content version as “0.1”.

On the other hand, if there is a content record that has the same content name as the content name included in the content data in the content DB 205, the content record generation unit 211 determines the same content ID as the content ID of the content record. At this time, the content record generation unit 211 determines the content version as the content version acquired from adding “0.1” to the content version included in the content record.

Thus, if a new piece of content is managed by the management apparatus 20, the content version of the piece of content is managed as “0.1”. On the other hand, if a piece of content already managed by the management apparatus 20 is changed, or the like, the content version of the piece of content is managed as the value acquired from adding “0.1” to the value of the latest content version.

According to the first embodiment, the content name of the content data of the piece of content 1202 is “design document for product B”, and there is a content record of the content ID “C003” having the same content name in the content DB 205 illustrated in FIG. 4. Therefore, in this case, the content record generation unit 211 generates a content record that includes the content ID “C003”, the content version “0.2”, the tag “design document”, and the content data that indicates the piece of content 1202.

Note that, if a piece of content already managed by the management apparatus 20 is changed, or the like, the content record generation unit 211 may generate a content record where difference data that indicates the difference between the piece of content of the immediately preceding version and the piece of content of the current version is set as the data item “content itself”. For example, as the data item “content itself” included in the content record having the content ID “C003” and the content version “0.2”, difference data that indicates the difference from the data item “content itself” included in the content record having the content ID “C003” and the content version “0.1” may be set. By setting the difference data from the piece of content of the immediately preceding version in the data item “content itself” included in the content record as mentioned above, it is possible to reduce the data amount of the content DB 205.

Next, the content registration unit 212 of the management apparatus 20 stores the content record generated by the content record generation unit 211 in the content DB 205 (step S712). Then, the content registration processing unit 202 of the management apparatus 20 transmits the stored content record to the terminal apparatus 10 (step S713).

When the display control unit 105 of the terminal apparatus 10 has received the content record from the management apparatus 20, the display control unit 105 displays a screen page 1300 such as the screen page illustrated in FIG. 9 on the display device 12 based on the content record (step S714).

In a display area 1301 of the screen page 1300 illustrated in FIG. 9, a display component 1302 representing the piece of content 1202 is added based on the received content record. Thus, the display component 1302 is added in the display area 1301. In the added display component 1302, the version, the tag, and the content name corresponding to the piece of content 1202 for which the user has performed the content registration operation are displayed.

Thus, according to the version management system 1 of the first embodiment, if a user U newly creates a piece of content or modifies a piece of content already managed using the terminal apparatus 10, the created or modified piece of content can be registered with the management apparatus 20. As a result, according to the version management system 1 of the first embodiment, it is possible to manage the version of the registered piece of content.

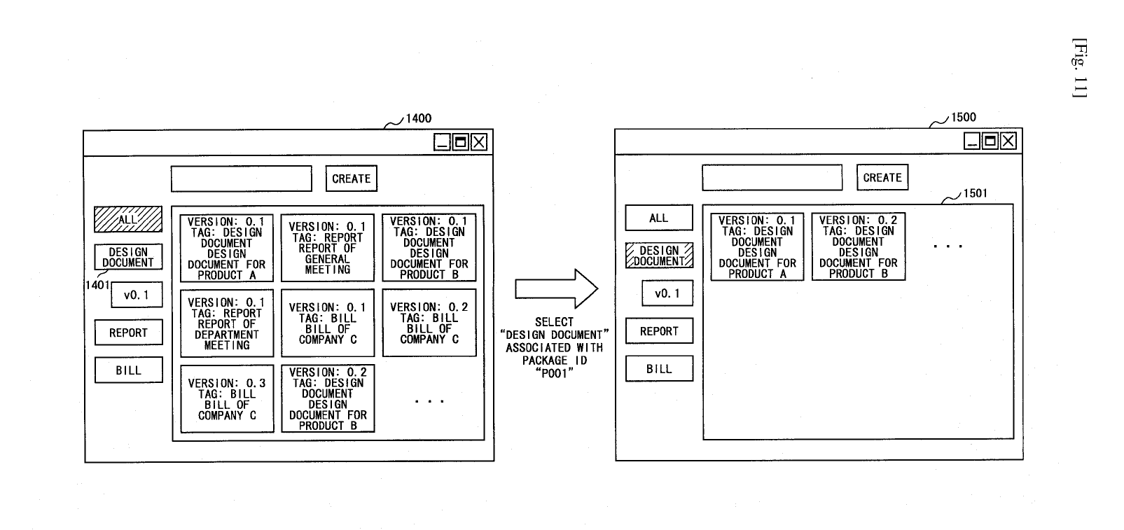

Next, a process of displaying a package that includes the pieces of content as the elements of the package on the terminal apparatus 10, carrying out versioning on the displayed package, and registering the package on which versioning has been carried out will be described with reference to FIG. 10. FIG. 10 is a sequence diagram illustrating one example of a package displaying and version registration process according to the first embodiment. Below, a description will be made for a case of displaying a list of pieces of content included in a design document package, carrying out versioning on the displayed design document package, and registering the design document package on which versioning has been carried out.

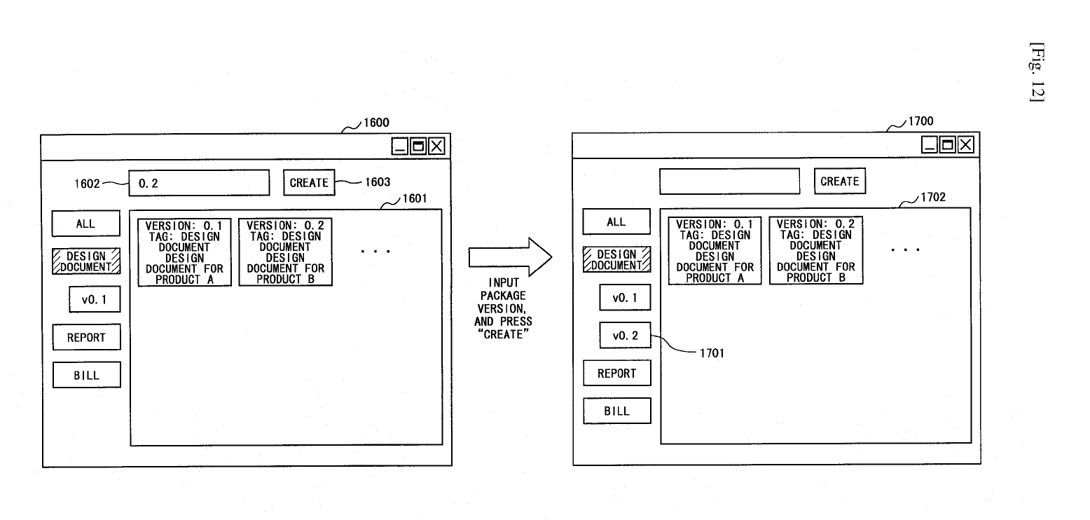

First, it is assumed that, on the display device 12 of the terminal apparatus 10, the display control unit 105 displays a screen page 1400 such as the screen page illustrated in FIG. 11.

A user U performs a package selection operation of pressing a “design document” button 1401 with which the package ID “P001” is associated to select the corresponding package to display, from the screen page 1400 illustrated in FIG. 11 (step S1001). The input reception unit 101 of the terminal apparatus 10 receives the package selection operation.

When the input reception unit 101 has received the package selection operation, the acquisition request unit 104 of the terminal apparatus 10 transmits a package acquisition request for acquiring the pieces of content included in the selected package to the management apparatus 20 (step S1002). The package acquisition request includes the package ID of the package selected through the package selection operation.

When the search condition acquisition unit 221 of the management apparatus 20 has received the package acquisition request, the search condition acquisition unit 221 acquires the package definition record corresponding to the package ID included in the package acquisition request from the package definition DB 206. The search condition acquisition unit 221 acquires the search condition included in the acquired package definition record (step S1003).

According to the first embodiment, the search condition acquisition unit 221 acquires the package definition record corresponding to the package ID “P001” included in the package acquisition request from the package definition DB 206. Then, the search condition acquisition unit 221 acquires the search condition “tag=design document” included in the acquired package definition record.

The search unit 222 of the management apparatus 20 searches the content DB 205 for the content records based on the search condition acquired by the search condition acquisition unit 221 (step S1004). That is, according to the first embodiment, the search unit 222 searches the content DB 205 based on the search condition “tag=design document” to acquire the content records each having the tag “design document” from the content DB 205. The search process in step S1004 will be described later in detail.

The package registration processing unit 203 of the management apparatus 20 transmits the content records acquired by the search unit 222 to the terminal apparatus 10 (step S1005).

When the display control unit 105 of the terminal apparatus 10 has received the content records from the management apparatus 20, the display control unit 105 displays a screen page 1500 such as the screen page illustrated in FIG. 11 on the display device based on the content records (step S1006).

In a display area 1501 of the screen page 1500 illustrated in FIG. 11, a list of the pieces of content is displayed based on the received content records. That is, in the display area 1501, a list of display components such as icons representing the pieces of content included in the design document package selected by the user U is displayed. In the display components, the content versions, the tags, and the content names included in the received content records are displayed, respectively. Thus, the user U can acquire the list of the content versions, the tags, and the content names of the pieces of content included in the design document package.

Thus, according to the version management system 1 of the first embodiment, a package is defined by the search condition for the tag included in the content record. Therefore, a user U need not explicitly designate the package that is to include a piece of content, to register the piece of content with the management apparatus 20. That is, according to the version management system 1 of the first embodiment, when a user U registers a piece of content with the management apparatus 20, the piece of content will be included in the suitable package according to the tag associated with the content data that indicates the piece of content.

On the other hand, for creating a package, a user creates a package definition record where a package ID and a search condition that defines the package identified by the package ID are designated. That is, also a user who creates a package need not explicitly designate the pieces of content to be included in the package.

Next, a process for carrying out versioning on a design document package displayed on the terminal apparatus 10, and registering the design document package on which versioning has been carried out will be described.

A user U inputs a package version in a version input field 1602 of a screen page 1600 such as the screen page illustrated in FIG. 12. In the screen page 1600, a list of the pieces of content included in the design document package is displayed in a display area 1601. Then, the user U performs a package registration operation of pressing a “create” button 1603 (step S1007). The input reception unit 101 of the terminal apparatus 10 receives the package registration operation. It is assumed that the user U inputs the package version “0.2” in the version input field 1602.

When the input reception unit 101 has received the package registration operation, the registration request unit 103 of the terminal apparatus 10 transmits a package version registration request for registering the version of the design document package to the management apparatus 20 (step S1008). The package version registration request includes the package ID of the design document package and the package version that has been input in version input field 1602.

When the configuration management record generation unit 223 of the management apparatus 20 has received the package version registration request, the configuration management record generation unit 223 generates configuration management records (step S1009).

In more detail, the configuration management record generation unit 223 generate configuration management records where the content IDs and the content versions of the content records acquired by the search unit 222 in step S1004 are associated with the package ID and the package version included in the package version registration request, respectively.

According to the first embodiment, the configuration management records are generated using the package version that has been input by the user U. However, it is not necessary to limit an embodiment in this way. That is, instead of the package version being input by the user U, the management apparatus 20 may determine the package version.

Retuning FIG. 10, next, the configuration management registration unit 224 of the management apparatus 20 stores the configuration management records generated by the configuration management record generation unit 223 in the configuration management DB 207 (step S1010). Then, the package registration processing unit 203 of the management apparatus 20 transmits the registered package version of the design document package to the terminal apparatus 10 (step S1011).

When the display control unit 105 of the terminal apparatus 10 has received the package version from the management apparatus 20, the display control unit 105 displays a screen page 1700 such as the screen page illustrated in FIG. 12 on the display device 12 based on the package version (step S1012).

In the screen page 1700 illustrated in FIG. 12, a “v0.2” button 1701 to display a list of pieces of content included in the design document package of the package version “0.2” registered with the management apparatus 20 is added. As a result, the user U can display the list of pieces of content included in the design document package of the package version “0.2” in the display area 1702 using the “v0.2” button 1701.

Thus, according to the version management system 1 of the first embodiment, it is possible to give a version to the package displayed based on the search condition included in a package definition record. That is, according to the version management system 1 of the first embodiment, a snapshot of a displayed package is registered in response to a user's registration operation, and the version of the package is managed. As a result, even when pieces of content included in a package are frequently added, or the like, a user can easily manage the corresponding versions of the package.

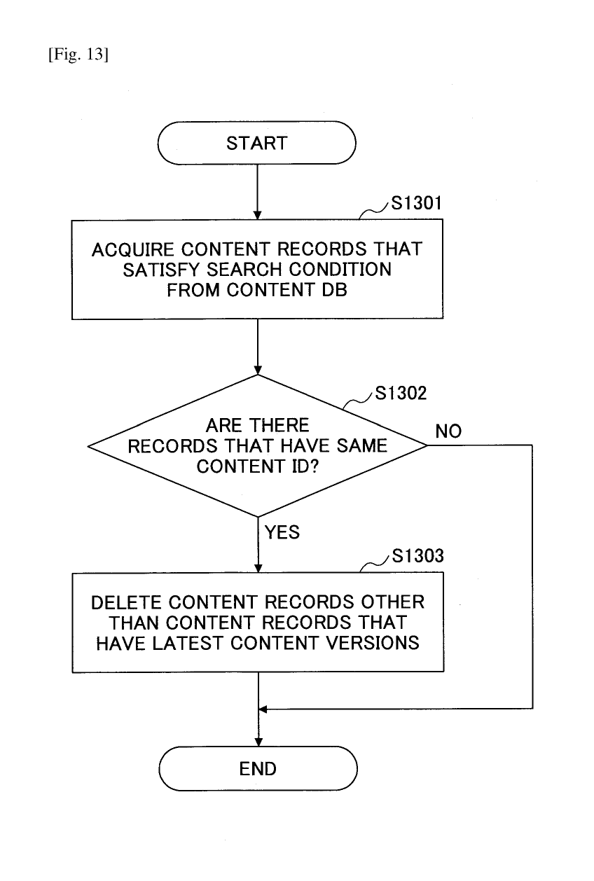

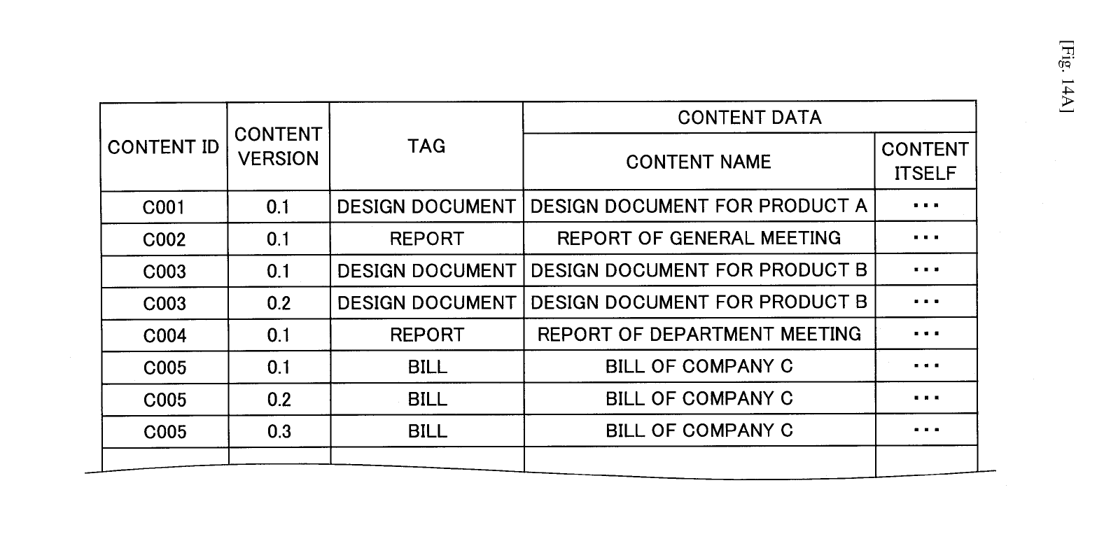

Next, the content record search process in step S1004 illustrated in FIG. 10 will be described with reference to FIG. 13. FIG. 13 is a flowchart illustrating one example of the content record search process according to the first embodiment.

First, the search unit 222 acquires the content records that satisfy the search condition acquired by the search condition acquisition unit 221 from the content DB 205 (step S1301).

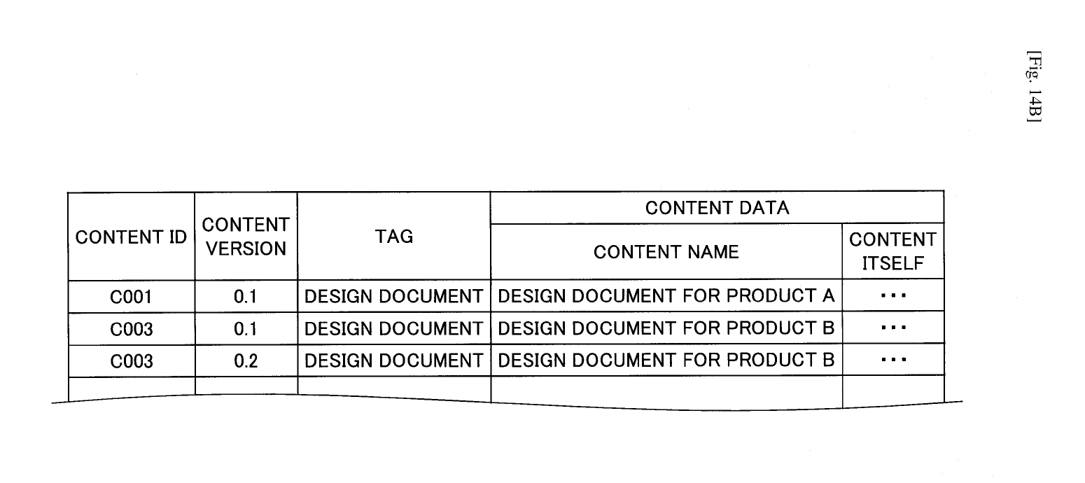

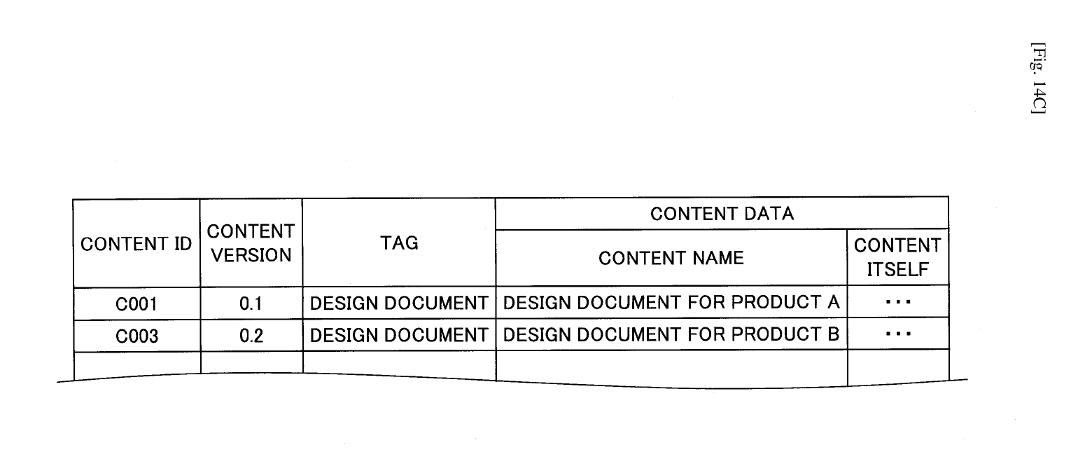

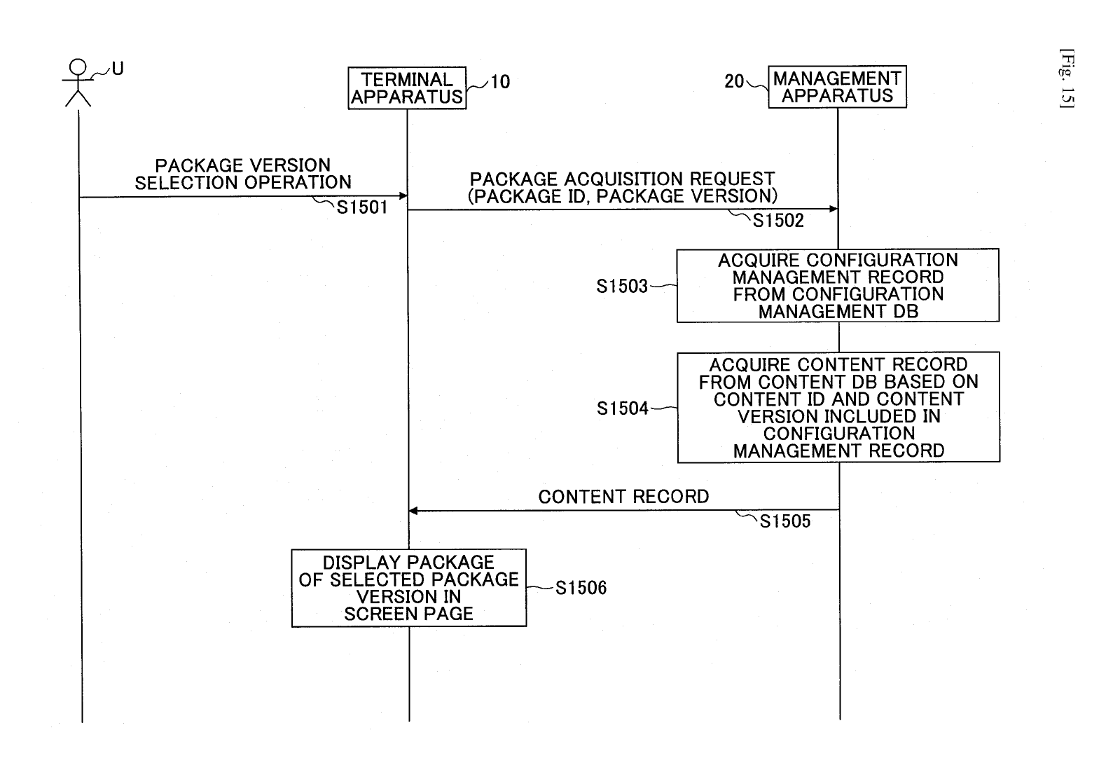

In more detail, assuming that the search condition acquired by the search condition acquisition unit 221 is, for example, “tag=design document”, the search unit 222 acquires the content records illustrated in FIG. 14B from the content DB 205 illustrated in FIG. 14A. that is, the search unit 222 acquires the content records each having the tag “design document” from among the content records included in the content DB 205 illustrated in FIG. 14A.

Next, the search unit 222 determines whether there are content records having the same content IDs in the content records acquired in step S1301 (step S1302).

If there are no content records having the same content IDs in step S1302, the search unit 222 ends the process. That is, in this case, the package registration processing unit 203 transmits the content records acquired by the search unit 222 in step S1301 to the terminal apparatus 10.

If there are the content records having the same content IDs in step S1302, the search unit 222 deletes the content records other than the content records having the latest content versions from among the content records having the same content IDs (step S1303). Thus, the search unit 222 acquires the content records after the deletion.

In more detail, concerning the content records having the same content IDs “C003” from among the content records illustrated in FIG. 14B, the search unit 222 deletes the content record other than the content record having the latest content version “0.2”. That is, the search unit 222 deletes the content record of the content ID “C003” having the content version “0.1”. Thus, the search unit 222 acquires the content records illustrated in FIG. 14C. In this case, the package registration processing unit 203 transmits the content records illustrated in FIG. 14C to the terminal apparatus 10.

Thus, according to the version management system 1 of the first embodiment, content records that are elements of a package are searched for based on a search condition, and are acquired. Therefore, a user U can define a package by setting a search condition without designating the pieces of content included in the package.

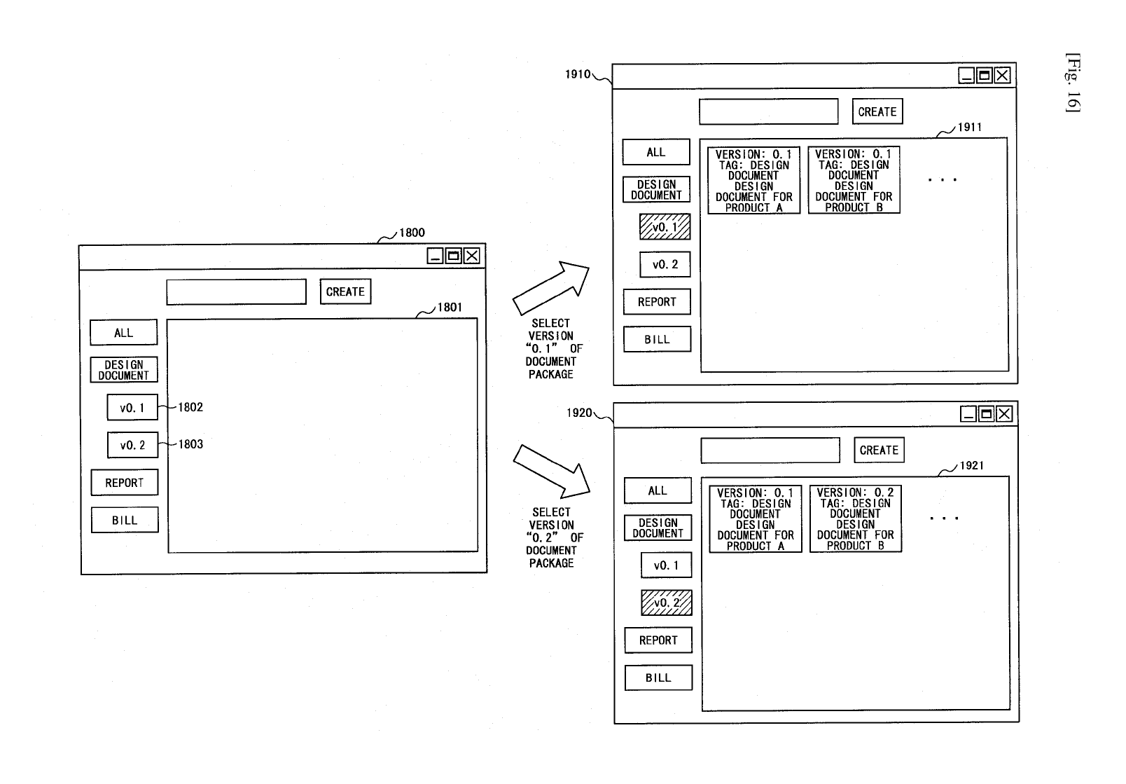

Next, a process of displaying a list of the pieces of content included in a package that has been registered after versioning has been carried out on the package will be described with reference to FIG. 15. FIG. 15 is a sequence diagram illustrating one example of a process of displaying a package of a certain version according to the first embodiment.

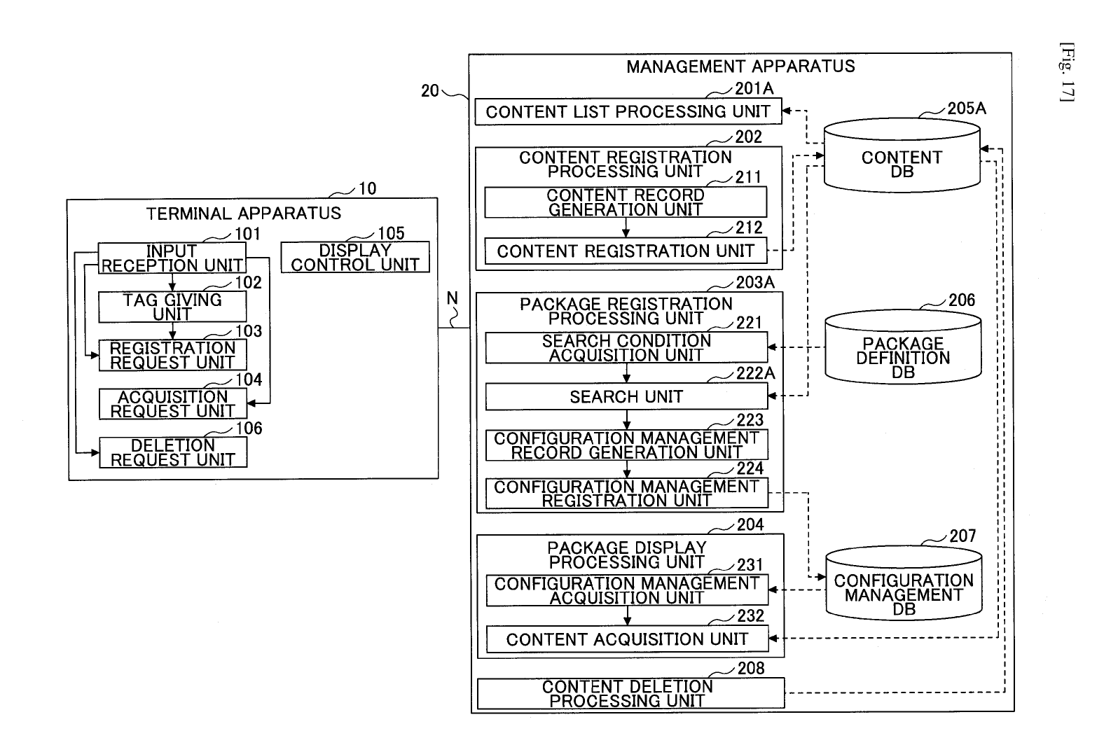

First, it is assumed that the display device 12 of the terminal apparatus 10 displays a screen page 1800 such as the screen page illustrated in FIG. 16 through the display control unit 105. Below, a description will be made for a case to display a list of the pieces of content included in a design document package having the package version “0.1” in a display area 1801.

A user U performs a package version selection operation of pressing a “v0.1” button 1802 for displaying a list of the pieces of content included in the design document package of the package version “0.1” from the screen page 1800 illustrated in FIG. 16 (step S1501). The input reception unit 101 of the terminal apparatus 10 receives the package version selection operation.

The “v0.1” button 1802 is associated with the package ID “P001” of the design document package and the package version “0.1”. In the same way, in the screen page 1800, the “v0.2” button 1803 is associated with the package ID “P001” of the design document package and the package version “0.2”.

When the input reception unit 101 has received the package version selection operation, the acquisition request unit 104 of the terminal apparatus 10 transmits a package acquisition request for acquiring the pieces of content included in the package of the selected package version to the management apparatus 20 (step S1502). The package acquisition request includes the package ID and the package version of the package selected through the package version selection operation.

When the configuration management acquisition unit 231 of the management apparatus 20 has received the package acquisition request, the configuration management acquisition unit 231 acquires the configuration management records corresponding to the package ID and the package version included in the package acquisition request from the configuration management DB 207 (step S1503). That is, according to the first embodiment, the configuration management acquisition unit 231 acquires the configuration management records each having the package ID “P001” and the package version “0.1” from the configuration management DB 207.

Next, the content acquisition unit 232 of the management apparatus 20 acquires the content records corresponding to the content IDs and the content versions included in the configuration management records acquired by the configuration management acquisition unit 231 from the content DB 205 (step S1504). That is, according to the first embodiment, the content acquisition unit 232 acquires the content records of the pieces of content included in the design document package (the package ID “P001”) having the package version “0.1” from the content DB 205.

Then, the package display processing unit 204 transmits the content records acquired by the content acquisition unit 232 to the terminal apparatus 10 (step S1505).

When the display control unit 105 of the terminal apparatus 10 has received the content records from the management apparatus 20, the display control unit 105 displays a screen page 1910 such as the screen page illustrated in FIG. 16 on the display device 12 based on the content records (step S1506). That is, the display control unit 105 displays a list of display components representing the pieces of content included in the design document package of the package version “0.1” selected by the user U in a display area 1911. As a result, the user U can acquire the list of the content versions, the tags, and the content names of the pieces of content included in the package of the registered package version.

If the user U presses a “v0.2” button 1803 from the screen page 1800, the display device 12 of the terminal apparatus 10 displays a screen page 1920 such as the screen page illustrated in FIG. 16. In the screen page 1920, a list of display components representing the pieces of content included in the design document package of the package version “0.2” selected by the user U is displayed in a display area 1921.

Thus, according to the version management system 1 of the first embodiment, it is possible to display a list of the pieces of content included in a package on which versioning has been carried out.

### Second Embodiment

Next, a version management system 1 according to a second embodiment will be described. In the description for the second embodiment, differences from the first embodiment will be described, the same or similar reference signs are given to elements having the same or similar functional configurations as the elements of the first embodiment, and duplicate descriptions will be omitted.

According to the second embodiment, a user of a terminal apparatus 10 can delete a piece of content managed by a management apparatus 20.

<Functional Configuration>

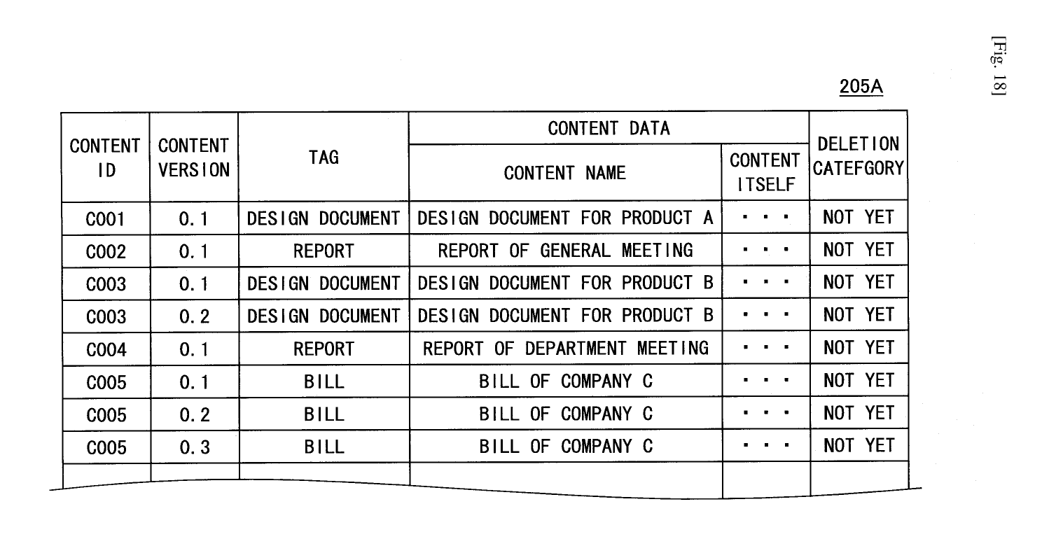

Next, a functional configuration of the version management system 1 according to the second embodiment will be described with reference to FIG. 17. FIG. 17 illustrates one example of a functional configuration of the version management system 1 according to the second embodiment.

The terminal apparatus 10 illustrated in FIG. 17 has a deletion request unit 106. The deletion request unit 106 is implemented by a process carried out by the CPU 16 according to the terminal program 30 installed in the terminal apparatus 10.

The deletion request unit 106 responds to an input operation that the input reception unit 101 has received, to transmit a content deletion request to the management apparatus 20.

The management apparatus 20 illustrated in FIG. 17 has a content list processing unit 201A, a package registration processing unit 203A, and a content deletion processing unit 208. These units are implemented by processes carried out by the CPU 16 according to the version management program 40 installed in the management apparatus 20.

Also, the management apparatus 20 illustrated in FIG. 17 has a content DB 205A. The content DB 205A can be implemented by the HDD 18, or the like.

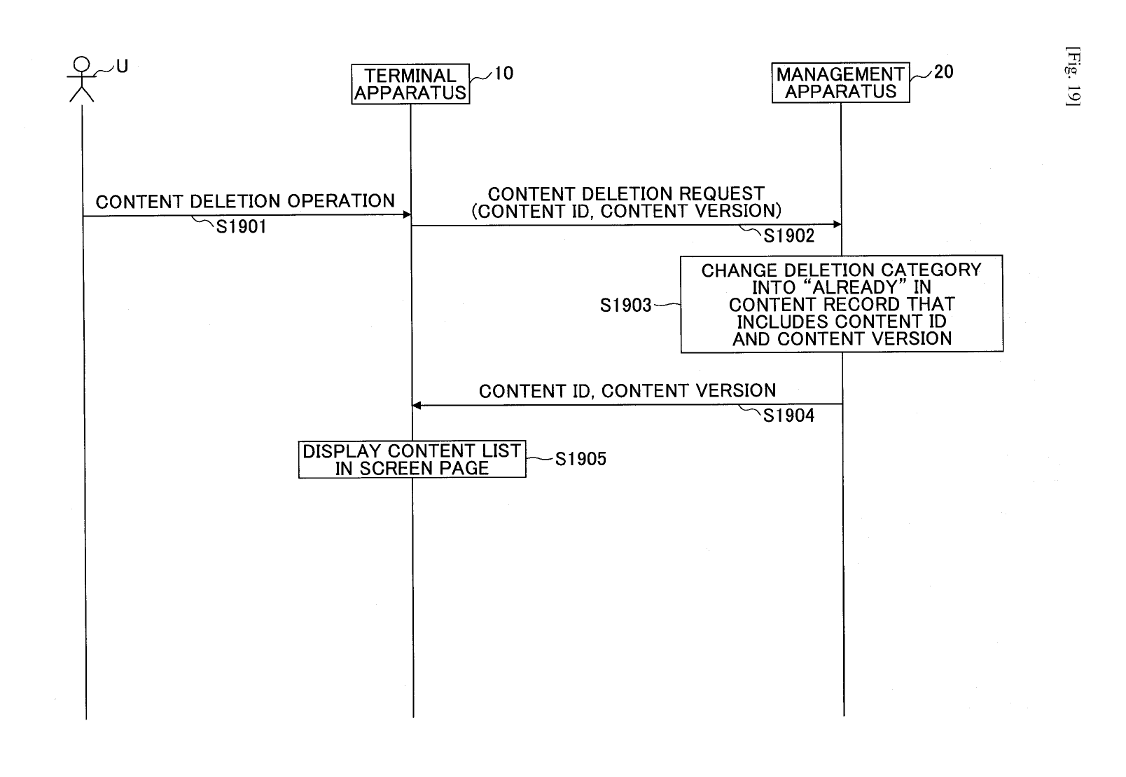

The content DB 205A manages content records. The content DB 205A will now be described in detail with reference to FIG. 18. FIG. 18 illustrates one example of the content DB according to the second embodiment.

As illustrated in FIG. 18, each of content records managed by the content DB 205A further has a data item, i.e., a deletion category. The data item “deletion category” is information indicating whether a content deletion request has been transmitted. That is, according to the management apparatus 20 of the second embodiment, when a content deletion request has been received from the terminal apparatus 10, the deletion category of the content record corresponding to the content deletion request is updated into “already”.

Thus, according to the management apparatus 20 of the second embodiment, the content record corresponding to a content deletion request is not immediately deleted, and the corresponding deletion category is updated into “already”. As a result, according to the version management system 1 of the second embodiment, it is possible to, for example, easily rollback the content DB 205A. Note that, a content record having the deletion category of “already” may be actually deleted at a time of, for example, periodical maintenance of the content DB 205A.

The content list processing unit 201A responds to a content acquisition request for displaying a list of pieces of content managed by the management apparatus 20, to acquire the corresponding content records from the content DB 205A. The content list processing unit 201A acquires content records from among the content records stored in the content DB 205A depending on the deletion category. That is, the content list processing unit 201A acquires the content records each of which has the deletion category of “not yet” from the content DB 205A.

The content deletion processing unit 208 responds to a content deletion request for deleting a piece of content from the management apparatus 20, to carry out a process to delete the piece of content from the management apparatus 20. Actually, the content deletion processing unit 208 responds to a content deletion request, to update the deletion category of the content data corresponding to the content deletion request stored in the content DB 205A into “already”.

The package registration processing unit 203A has a search unit 222A. The search unit 222A searches the content DB 205 based on a search condition acquired by the search condition acquisition unit 221, to acquire the content records each of which has the deletion category of “not yet” from among the content records each of which satisfies the search condition.

<Process Detail>

Next, the process of the version management system 1 according to the second embodiment will be described in detail.

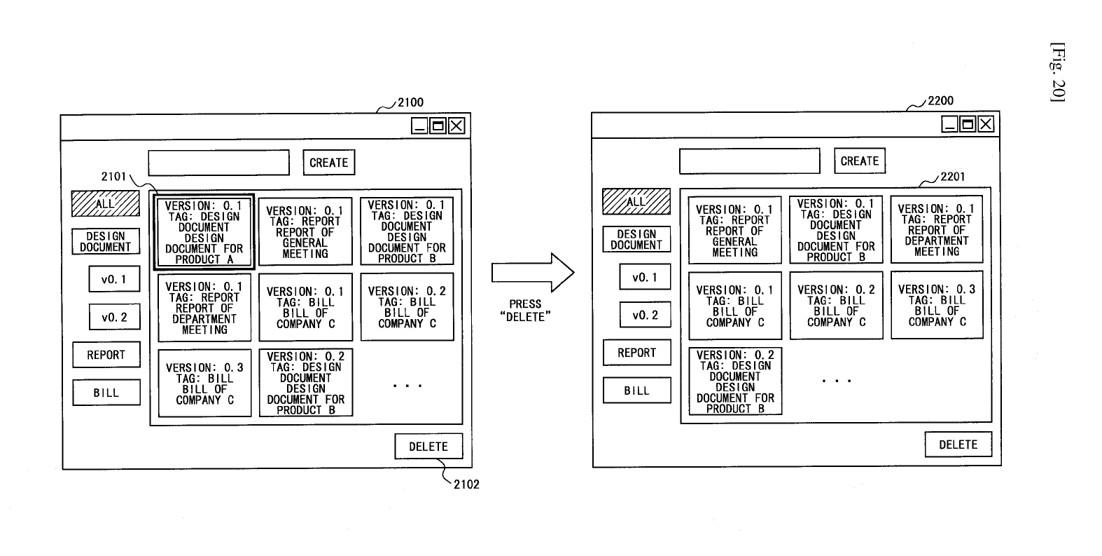

First, a process for a user U to delete a piece of content managed by the management apparatus 20 using the terminal apparatus 10 will be described with reference to FIG. 19. FIG. 19 is a sequence diagram illustrating one example of a content deletion process according to the second embodiment.

First, it is assumed that, on the display device 12 of the terminal apparatus 10, the display control unit 105 displays a screen page 2100 such as the screen page illustrated in FIG. 20.

The user U performs a content deletion operation of selecting a display component 2101, such as an icon representing a piece of content to be deleted, and then pressing a “delete” button 2102, from the screen page 2100 (step S1901). The input reception unit 101 of the terminal apparatus 10 receives the content deletion operation.

When the input reception unit 101 has received the content deletion operation, the deletion request unit 106 of the terminal apparatus 10 transmits a content deletion request for deleting the selected piece of content to the management apparatus 20 (step S1902). The content deletion request includes the content ID and the content version of the selected piece of content.

When the content deletion processing unit 208 of the management apparatus 20 has received the content deletion request, the content deletion processing unit 208 updates the deletion category of the content record corresponding to the content ID and the content version included in the content deletion request into “already” in the content DB 205A (step S1903). Thus, the deletion category of the content record of the piece of content selected by the user U is updated into “already”.

The content deletion processing unit 208 of the management apparatus 20 transmits the content ID and the content version of the content record in which the deletion category has been updated into “already” to the terminal apparatus 10 (step S1904).

When the display control unit 105 of the terminal apparatus 10 has received the content ID and the content version from the management apparatus 20, the display control unit 105 displays a screen page 2200 such as the screen page illustrated in FIG. 20 on the display device 12 (step S1905).

In the screen page 2200 illustrated in FIG. 20, the display component 2101 selected by the user U to delete is deleted in the display area 2201. Thus, according to the second embodiment, the piece of content indicated by a content record in which the deletion category is “already” is not displayed in the display area 2201.

Thus, according to the version management system 1 of the second embodiment, by updating the deletion category of a content record managed by the management apparatus 20 into “already”, it is possible to delete the corresponding piece of content.

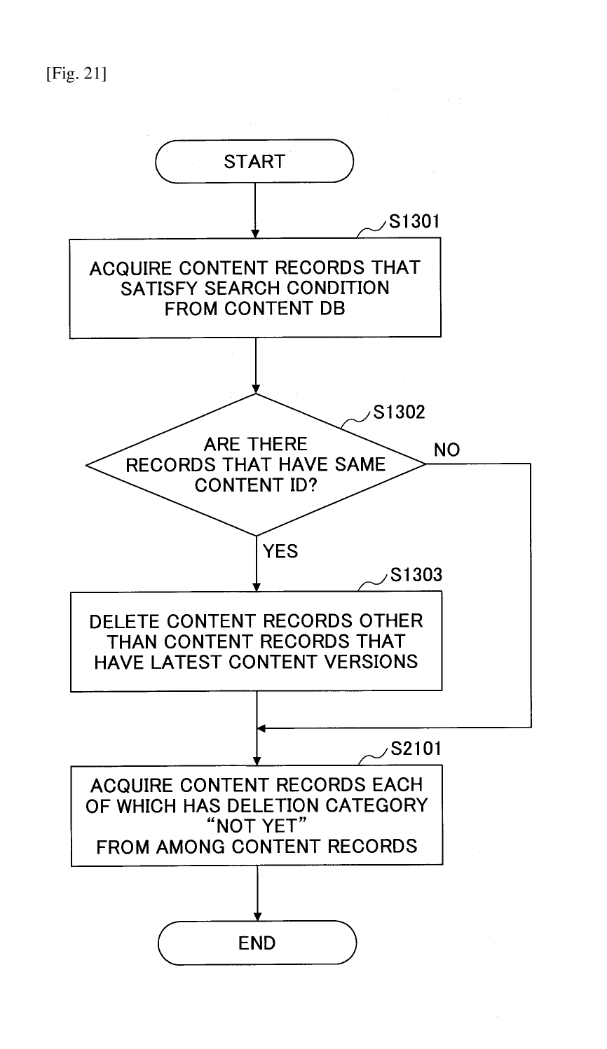

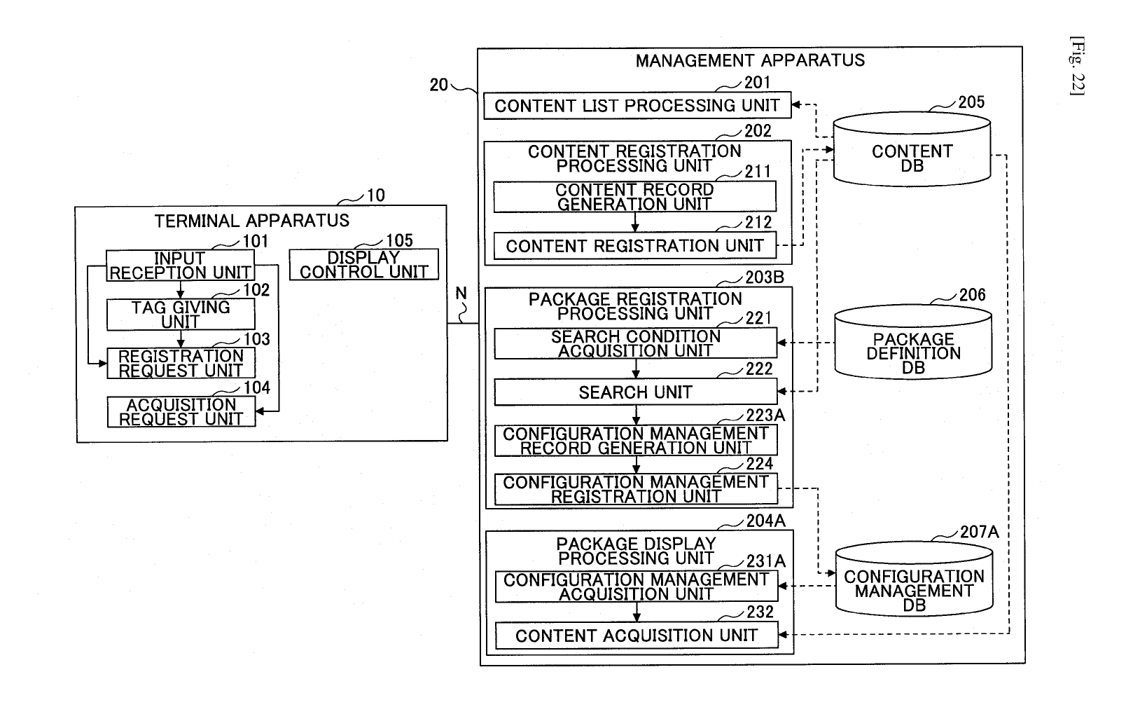

Next, a content record search process according to the second embodiment will be described with reference to FIG. 21. FIG. 21 is a flowchart illustrating one example of a content record search process according to the second embodiment.

The search unit 222A acquires the content records each of which has the deletion category of “not yet” from among the content records acquired in step S1301 (step S2101). That is, the search unit 222A does not acquire the content records each of which has the deletion category of “already” from among the content records acquired in step S1301. Thus, the content records of the pieces of content concerning the content deletion request are not included in the package selected by the user U.

Thus, according to the version management system 1 of the second embodiment, as a result of not acquiring content records each of which has the deletion category of “already” as search results, it is possible to not include the pieces of content indicated by the content records in a package.

Therefore, if a user U wishes to delete a piece of content, it is sufficient to perform a content deletion operation, without explicitly deleting the piece of content from the package. Therefore, the user can easily manage the versions of packages even when pieces of content included in the packages are frequently deleted, or the like.

### Third Embodiment

Next, a version management system 1 according to a third embodiment will be described. In the description of the third embodiment, the differences from the first embodiment will be described, the same or similar reference signs are given to elements having the same or similar functional configurations as the elements of the first embodiment, and duplicate descriptions will be omitted.

The third embodiment associates packages with periods of time during which the packages are valid. As a result, by designating a date in a terminal apparatus 10, it is possible to display a list of the pieces of content included in the packages valid at the date.

<Functional Configuration>

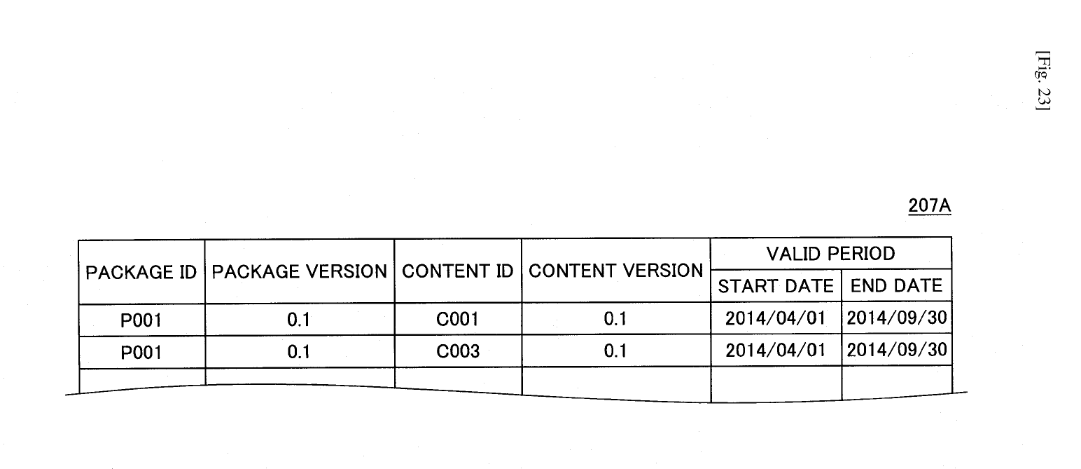

Next, a functional configuration of the version management system 1 according to the third embodiment will be described with reference to FIG. 22. FIG. 22 illustrates one example of a functional configuration of the version management system according to the third embodiment.

A management apparatus 20 illustrated in FIG. 22 has a package registration processing unit 203B and a package display processing unit 204A. These units are implemented by processes carried out by the CPU 16 according to the version management program 40 installed in the management apparatus 20.

Also, the management apparatus 20 illustrated in FIG. 22 has a configuration management DB 207A. The configuration management DB 207A can be implemented by HDD 18, or the like.

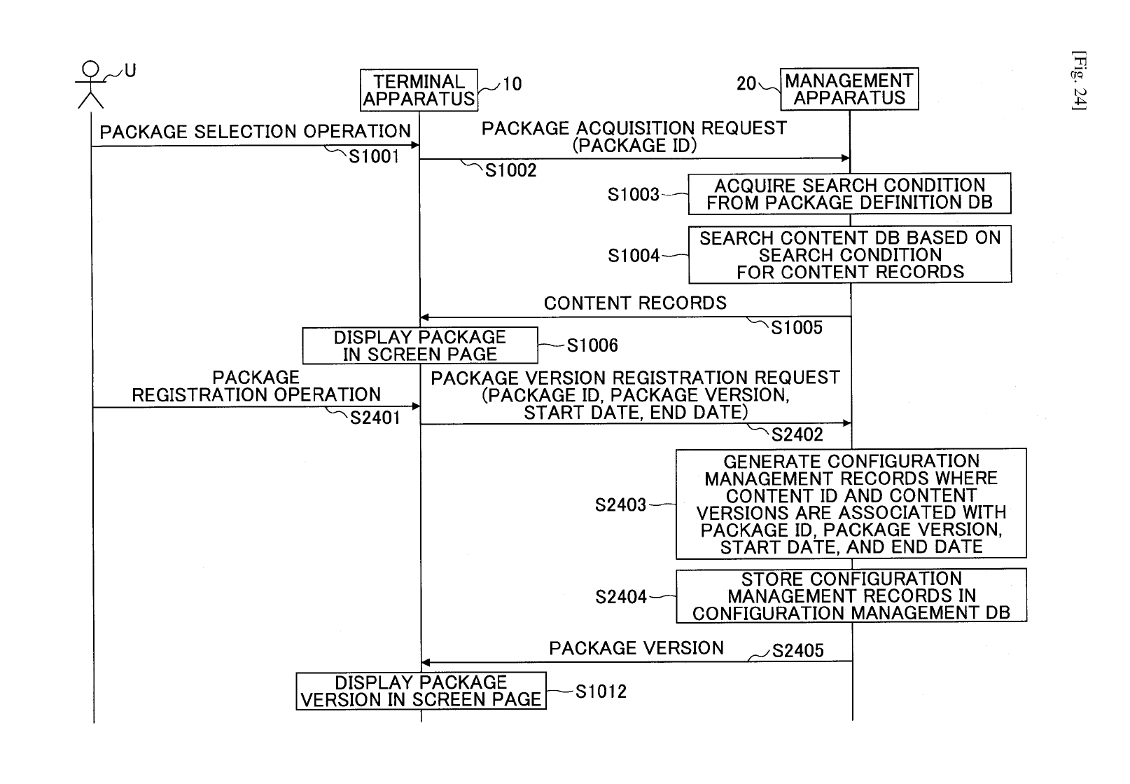

The configuration management DB 207A manages configuration management records. The configuration management DB 207A will now be described in detail with reference to FIG. 23. FIG. 23 illustrates one example of the configuration management DB according to the third embodiment.

As illustrated in FIG. 23, each of configuration management records managed by the configuration management DB 207A further has a data item, i.e., a valid period. The data item “valid period” includes a start date indicating a date from when a corresponding package becomes valid and an end date indicating a date from when the corresponding package becomes invalid.

As a result, the package indicated by a configuration management record for which the start date is set becomes valid from the date that is set. On the other hand, the package indicated by a configuration management record for which the end date is set becomes invalid from the date that is set. That is, a package having the package ID included in a configuration management record is valid on or after the start date and on or before the end date.

A package that is valid (a valid package) is such a package that it is possible to use the package. That is, for example, the pieces of content included in the corresponding package can be acquired, deleted, modified, and so forth. On the other hand, a package that is invalid (an invalid package) is such a package that it is not possible to use the package.

Note that, a package having the package ID included in a configuration management record having the start date of a blank (i.e., no date has been set as the start date) may be regarded as an invalid package. Also, a package having the package ID included in a configuration management record having the end date of a blank (i.e., no date has been set as the end date) may be regarded as a valid package.

The package registration processing unit 203B has a configuration management record generation unit 223A. The configuration management record generation unit 223A responds to a package version registration request, to generate configuration management records. In more detail, the configuration management record generation unit 223A generates configuration management records where the content IDs and the content versions of content records are associated with the package ID, the package version, and the valid period included in the package version registration request.

The package display processing unit 204A has a configuration management acquisition unit 231A. The configuration management acquisition unit 231A responds to a package acquisition request, to acquire the configuration management records of the valid packages corresponding to the package ID and the package version included in the package acquisition request from the configuration management DB 207.

<Process Detail>

Next, the process of the version management system 1 according to the third embodiment will be described in detail.

First, a process of displaying a package having the pieces of content as elements on the terminal apparatus 10, carrying out versioning on the displayed package, and registering the package on which versioning has been carried out will be described with reference to FIG. 24. FIG. 24 is a sequence diagram illustrating one example of a package displaying and version registration process according to the third embodiment.

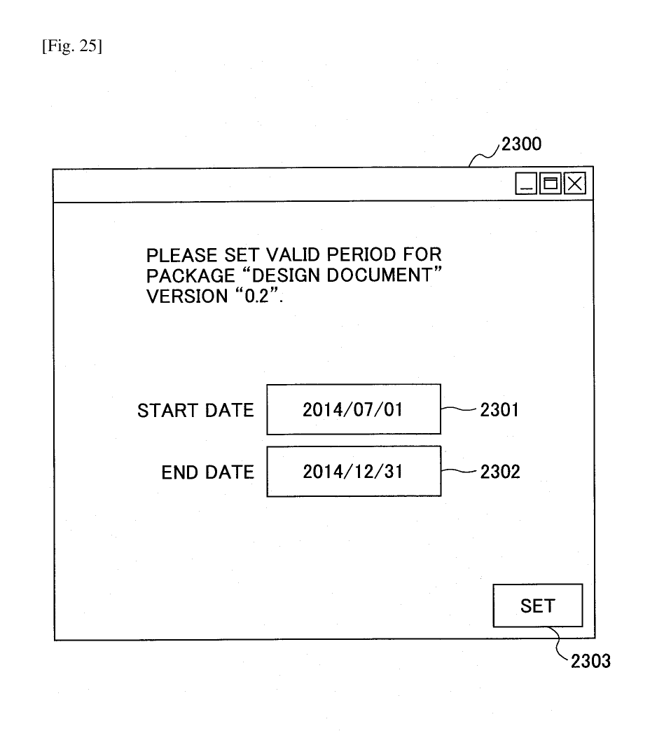

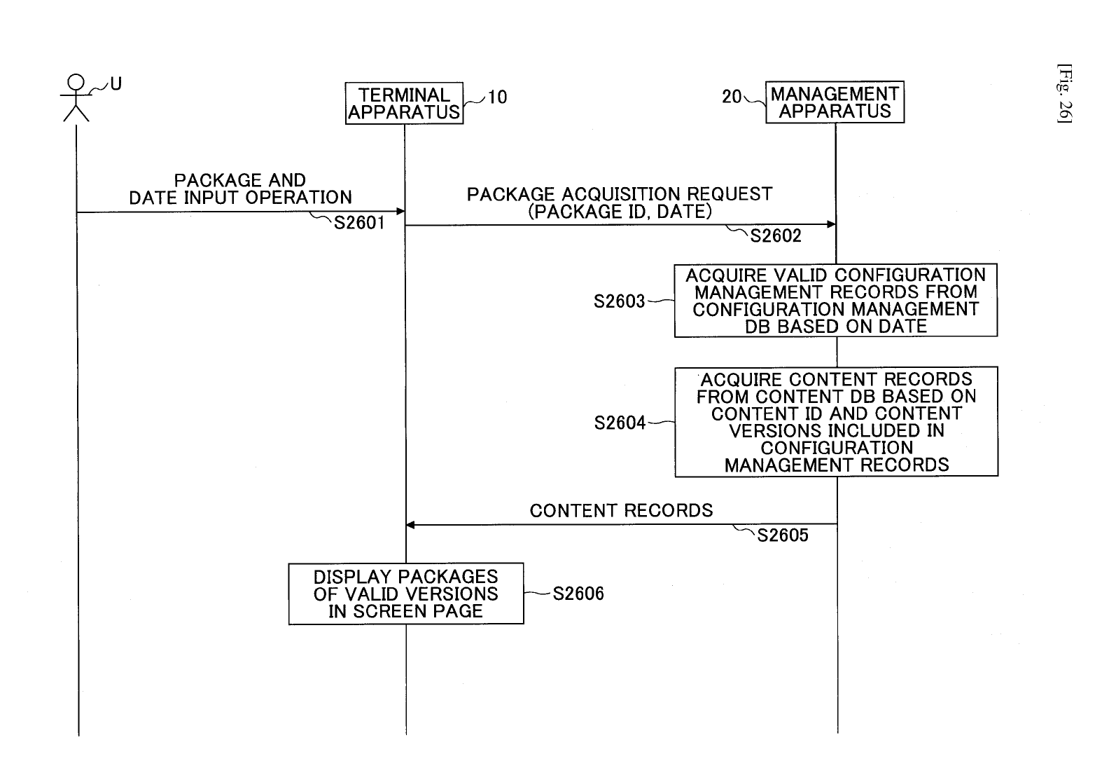

It is assumed that the terminal apparatus 10 displays a screen page 2300 such as the screen page illustrated in FIG. 25 for a user to set a valid period of a design document package on which versioning has been carried out, when versioning is carried out on the design document package displayed in step S1006 and the design document package on which versioning has been carried out is registered.

The screen page 2300 illustrated in FIG. 25 includes a start input field 2301 to input the start date of a valid period of the design document package having the package version “0.2” and an end input field 2302 to input the end date of the valid period of the design document package.

The user U performs a package registration operation of inputting a start date and an end date in the start input field 2301 and the end input field 2302, respectively, and then pressing a “set” button 2303, from the screen page 2300 illustrated in FIG. 25 (step S2401). The input reception unit 101 of the terminal apparatus 10 receives the package registration operation.

When the input reception unit 101 has received the package registration operation, the registration request unit 103 of the terminal apparatus 10 transmits a package version registration request for registering a version of the design document package to the management apparatus 20 (step S2402). The package version registration request includes the package ID of the design document package, the package version that has been input, the start date that has been input in the start input field 2301, and the end date that has been input in the end input field 2302.

When the configuration management record generation unit 223A of the management apparatus 20 has received the package version registration request, the configuration management record generation unit 223A generates configuration management records (step S2403).

In more detail, the configuration management record generation unit 223A generates configuration management records where the content IDs and the content versions of the content records acquired by the search unit 222 are associated with the package ID, the package version, the start date, and the end date. Note that the start date and the end date are associated with the content IDs and the content versions as data items included in the valid period.

Next, the configuration management registration unit 224 of the management apparatus 20 stores the configuration management records generated by the configuration management record generation unit 223A in the configuration management DB 207A (step S2404). Then, the package registration processing unit 203A of the management apparatus 20 transmits the package version of the registered design document package to the terminal apparatus 10 (step S2405).

Thus, according to the version management system 1 of the third embodiment, it is possible to set a valid period for a package of a version to be registered when the version is given to the package displayed based on the search condition included in a package definition record, and the package to which the version has been given is registered. As a result, the user U can set a start date from when the package of the registered version becomes valid, and an end date from when the package of the registered version becomes invalid.

Therefore, according to the version management system 1 of the third embodiment, it is possible to make a design document package for products that are sold during a certain period valid during the certain period, for example. Also, by setting an end date for when a manager of a package moves to another division due to a personnel reshuffle or the like, or retires, for example, it is possible to make the package invalid when the manager has moved or retired. Thus, according to the version management system 1 of the third embodiment, by setting a start date and an end date for a package, it is possible to make the package valid during a desired period.

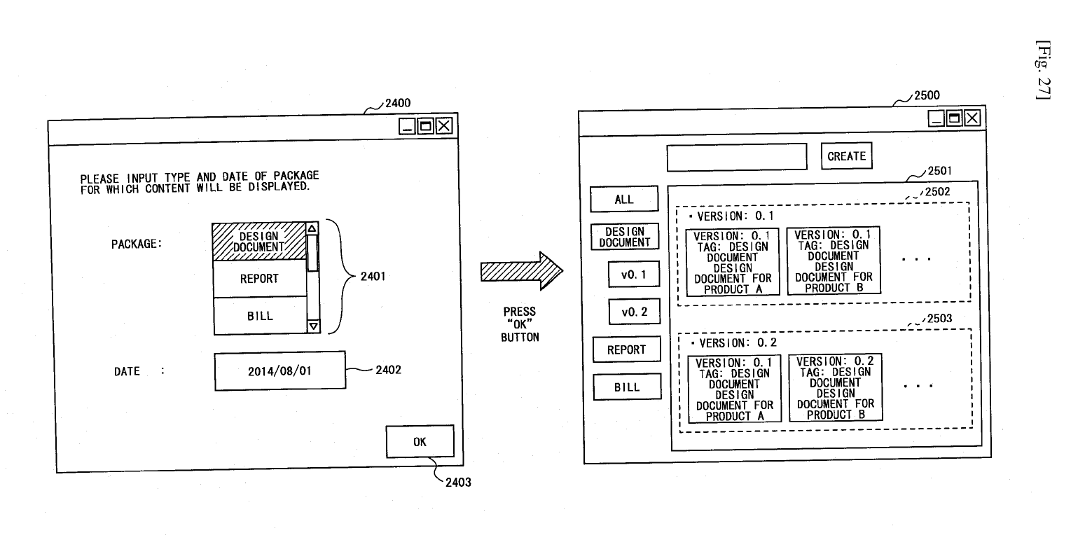

Next, a process to display a list of pieces of content included in the packages valid at a certain date designated by a user U from among registered packages on which versioning has been carried out will be described with reference to FIG. 26. FIG. 26 is a sequence diagram illustrating one example of a process to display the packages valid at a certain date according to the third embodiment.

Below, description will be made assuming that the terminal apparatus 10 displays a screen page 2400 such as the screen page illustrated in FIG. 27 to display the packages valid at a designated date from among registered packages on which versioning has been carried out.

The user U performs a package and date input operation of selecting a desired package from a package list 2401, inputting a date in a date input field 2402, and then pressing an “OK” button 2403, from the screen page 2400 illustrated in FIG. 27 (step S2601). The input reception unit 101 of the terminal apparatus 10 receives the package and date input operation.

When the input reception unit 101 has received the package and date input operation, the acquisition request unit 104 of the terminal apparatus 10 transmits a package acquisition request for acquiring the versions of the selected package valid at the date that has been input to the management apparatus 20 (step S2602). The package acquisition request includes the package ID of the package selected by the user and the date that has been input by the user.

The configuration management acquisition unit 231A of the management apparatus 20 acquires the configuration management records of the valid packages corresponding to the package ID included in the package acquisition request from the configuration management DB 207A (step S2603). That is, the configuration management acquisition unit 231A acquires the configuration management records each of which corresponds to the package ID included in the package acquisition request and has the start date on or before the date that has been input and the end date on or after the date that has been input.

Next, the content acquisition unit 232 of the management apparatus 20 acquires the content records corresponding to the content IDs and the content versions included in the configuration management records acquired by the configuration management acquisition unit 231A from the content DB 205 (step S2604).

Then, the package display processing unit 204A transmits the content records acquired by the content acquisition unit 232 to the terminal apparatus 10 (step S2605).

When the display control unit 105 of the terminal apparatus 10 has received the content records from the management apparatus 20, the display control unit 105 displays a screen page 2500 such as the screen page illustrated in FIG. 27 based on the content records on the display device 12 (step S2606).

In a display area 2501 of the screen page 2500 illustrated in FIG. 27, a list of pieces of content 2502 included in the design document package of the package version “0.1” valid at the date that has been input by the user U is displayed. In the same way, in the display area 2501, a list of pieces of content 2503 included in the design document package of the package version “0.2” also valid at the date that has been input by the user U is displayed.

Thus, according to the third embodiment, a list of all the pieces of content included in the packages of the versions valid at the date that has been input by the user U is displayed. As a result, according to the third embodiment, the user U can acquire the packages of all the versions valid at the date that is set.

Thus, according to the version management system 1 of the third embodiment, it is possible to display the packages valid at a date that has been set by a user. As a result, if, for example, a user wishes to acquire the design documents for products that were sold during a past certain period, the user can acquire the packages of the design documents for the corresponding products by setting the corresponding dates.

Note that, according to the third embodiment, for a single package selected by a user, the same packages of all the versions valid at a date that is set by a user are displayed. However, an embodiment is not limited in this way. For example, it is also possible that a user selects a plurality of packages, and, concerning the packages, all the packages of the versions valid at a date that is set by the user will be displayed.

Thus, the version management systems, the version management apparatuses, the programs, and the non-transitory recording media have been described in the embodiments. However, embodiments are not limited to the above-described embodiments, and various modifications and replacements may be made.

The present application is based on and claims the benefit of priority of Japanese Patent Application No. 2015-166704, filed on Aug. 26, 2015, the entire contents of which are hereby incorporated herein by reference.

### CITATION LIST

### Patent Literature

[PTL 1] Japanese Patent No. 3613504

### REFERENCE SIGNS LIST

1 a version management system
10 a terminal apparatus
20 a management apparatus
30 a terminal program
40 a version management program
101 an input reception unit
102 a tag giving unit
103 a registration request unit
104 an acquisition request unit
105 a display control unit
201 a content list processing unit
202 a content registration processing unit
203 a package registration processing unit
204 a package display processing unit
205 a content database
206 a package definition database
207 a configuration management database
211 a content record generation unit
212 a content registration unit
221 a search condition acquisition unit
222 a search unit
223 a configuration management record generation unit
224 a configuration management registration unit
231 a configuration management acquisition unit
232 a content acquisition unit

1. A version management system for managing versions of packages each of which includes one or more pieces of content, the version management system comprising:
an acquisition unit configured to search, based on a search condition defined for each package, a content database for managing content records each of which indicates a piece of content, for content records that indicate pieces of content included in the package corresponding to the search condition; and
a configuration management unit configured to store, for each of the content records acquired by the acquisition unit, a configuration management record in which identification information for identifying the package corresponding to the search condition is associated with first version information that indicates a version of the package, in a configuration management database.

2. The version management system according to claim 1, wherein
the search condition is a condition concerning tag information included in each of the content records managed by the content database, and
the acquisition unit is configured to acquire, from among the content records managed by the content database, the content records each of which includes the tag information that satisfies the search condition.

3. The version management system according to claim 2, wherein
each of the content records managed by the content database includes a content ID for identifying a piece of content indicated by the content record and second version information that indicates a version of the piece of content, and
the acquisition unit is configured to, if the content records each of which includes the tag information that satisfies the search condition include content records having the same content IDs, acquire a content record having the latest second version information from among the content records that have the same content IDs.

4. The version management system according to claim 2, wherein
each of the content records managed by the content database includes deletion category information that indicates whether deletion of a piece of content indicated by the content record has been requested, and
the acquisition unit is configured to acquire content records each of which has deletion category information indicating that deletion of a piece of content indicated by the content record is not requested.

5. The version management system according to claim 1, further comprising:
a display unit configured to transmit the content records acquired by the acquisition unit to a terminal apparatus connected to the version management system via a network, and to display, on the terminal apparatus, the package that includes the pieces of content indicated by the content records,
wherein
the configuration management unit is configured to store, for each of the content records acquired by the acquisition unit, the configuration management record in which the identification information is associated with the first version information that is set on the package displayed on the terminal apparatus, in the configuration management database.

6. A version management apparatus for managing versions of packages each of which includes one or more pieces of content, the version management apparatus comprising:
an acquisition unit configured to search, based on a search condition defined for a package, a content database for managing content records each of which indicates a piece of content, for content records that indicate pieces of content included in the package corresponding to the search condition; and
a configuration management unit configured to store, for each of the content records acquired by the acquisition unit, a configuration management record in which identification information for identifying the package corresponding to the search condition is associated with first version information that indicates a version of the package, in a configuration management database.

7. (canceled)

8. A non-transitory recording medium that stores therein a program, the program causing a version management apparatus for managing versions of packages each of which includes one or more pieces of content to function as:
an acquisition unit configured to search, based on a search condition defined for a package, a content database for managing content records each of which indicates a piece of content, for content records that indicate pieces of content included in the package corresponding to the search condition; and
a configuration management unit configured to store, for each of the content records acquired by, the acquisition unit, a configuration management record in which identification information for identifying the package corresponding to the search condition is associated with first version information that indicates a version of the package, in a configuration management database.

9. The version management system according to claim 1, further comprising:
a display unit configured to display, on a display device of a terminal apparatus that is connected to the version management system via a network, a screen page that includes display components for displaying display components that represent the pieces of content included in different versions of the package, respectively.

10. The version management apparatus according to claim 6, further comprising:
a display unit configured to display, on a display device of a terminal apparatus that is connected to the version management apparatus via a network, a screen page that includes display components for displaying display components that represent the pieces of content included in different versions of the package, respectively.

11. (canceled)

12. A The non-transitory recording medium according to claim 8, wherein
the program further causes the version management apparatus to function as:
a display unit configured to display, on a display device of a terminal apparatus that is connected to the version management apparatus via a network, a screen page that includes display components for displaying display components that represent the pieces of content included in different versions of the package, respectively.
